(19) United States
(12) Patent Application Publication
(10) Pub. No.: US 2009/0174640 A1
(43) Pub. Date: Jul. 9, 2009

(54) DISPLAY ELEMENT, IMAGE REWRITING METHOD FOR THE DISPLAY ELEMENT, AND ELECTRONIC PAPER AND ELECTRONIC TERMINAL UTILIZING THE DISPLAY ELEMENT

(75) Inventors: Masaki NOSE, Kawasaki (JP); Toshiaki YOSHIHARA, Kawasaki (JP); Tomohisa SHINGAI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/407,895

(22) Filed: Mar. 20, 2009

Related U.S. Application Data
(63) Continuation of application No. PCT/JP2006/319253, filed on Sep. 28, 2006.

(51) Int. Cl. G09G 5/02

(52) U.S. Cl. 345/88; 345/94

(57) ABSTRACT

The present invention relates to a display element, an image rewriting method for the display element, and electronic paper and an electronic terminal utilizing the display element and provides a display element having high display quality, an image rewriting method for the display element, and electronic paper and an electronic terminal utilizing the display element. Based on information on the temperatures and times at which first and second image rewrites are performed and information on the size and position of a region which is the subject of a partial rewrite, a selection is made to rewrite a display area as a whole or a region that is a part of the display area including the region under a partial rewrite when the second rewrite is performed.

This application is a continuation of International Application No. PCT/JP2006/319253, filed Sep. 28, 2006.

### BACKGROUND

1. Field

The present invention relates to a display element, an image rewriting method for the display element, and electronic paper and an electronic terminal utilizing the display element.

2. Description of the Related Art

Recently, various enterprises and universities are actively engaged in the development of electronic paper. The most promising field of application of electronic paper is electronic books, and other promising fields include the field of portable apparatus such as mobile terminal sub-displays and display sections of IC cards. One type of display elements used in electronic paper is liquid crystal display elements utilizing a liquid crystal composition which forms a cholesteric phase (such a component is called a cholesteric liquid crystal or chiral nematic liquid crystal and will hereinafter be referred to using the term “cholesteric liquid crystal). A liquid crystal display element utilizing a cholesteric liquid crystal has excellent characteristics such as semi-permanent display retention characteristics (memory characteristics), vivid color display characteristics, high contrast characteristics, and high resolution characteristics.

A cholesteric liquid crystal is a liquid crystal which has a choresteric phase in which nematic liquid crystal molecules have a helical twist by adding a relatively great amount (several tens percent) of chiral additive (which is also called a chiral material) to a nematic liquid crystal. A cholesteric liquid crystal has bistability (memory characteristics), and the liquid crystal can be put in any of a planar state, a focal conic state, and an intermediate state that is a mixture of the planar state and the focal conic state by adjusting the intensity of an electric field applied to the same. Once the liquid crystal enters the planar state, the focal conic state, or the mixed or intermediate state, the liquid crystal thereafter remains in the state with stability even under the nonelectrolytic field.

A principle behind a display operation of a liquid crystal display element utilizing a cholesteric liquid crystal will now be described. FIGS. 24A and 24B show a display section 6 of the liquid crystal display element. Dispicted as FIGS. 24A and 24B, the display section 6 includes a pair of substrates, i.e., a top substrate 11 and a bottom substrate 12 and a liquid crystal layer 15 enclosed between the substrates 11 and 12. A plurality of scan electrodes (not depicted) in the form of strips are formed in parallel with each other on the side of the top substrate 11 facing the liquid crystal layer 15. A plurality of data electrodes (not depicted) in the form of strips are formed in parallel with each other on the side of the bottom substrate 12 facing the liquid crystal layer 15, the data electrodes being disposed across the plurality of scan electrodes.

FIG. 24A shows a state of alignment of cholesteric liquid crystal molecules 63 observed when the liquid crystal layer 15 of the display section 6 is in the planar state. Depicted as FIG. 24A, in the planar state, the liquid crystal molecules 63 are sequentially rotated from one another in the direction of the thickness of the substrates to form a helical structure, and the helical axes of the helical structure are substantially perpendicular to the substrate surfaces.

In the planar state, light rays having predetermined wavelengths in accordance with the helical pitch of the liquid crystal molecules 63 are selectively reflected by the liquid crystal layer. A wavelength λ which results in the maximum reflection is given by an equation λ=n·p where n and p represent the average refractive index and the helical pitch of the liquid crystal, respectively. A reflection band width Δλ increases with reflective index anisotropy. Δn of the liquid crystal.

For example, when blue light is to be selectively reflected by the liquid crystal layer 15 of the display section 6 in the planar state, the average refractive index n and the helical pitch p are determined such that an equation “λ=480 nm” becomes true. The average refractive index n can be adjusted by selecting the liquid crystal material and the chiral material appropriately, and the helical pitch p can be adjusted by adjusting the chiral material content.

FIG. 24B shows a state of alignment of the cholesteric liquid crystal molecules 63 observed when the liquid crystal layer 15 of the display section 6 is in the focal conic state. Depicted as FIG. 24B, in the focal conic state, the liquid crystal molecules 63 are sequentially rotated from one another in an in-plane direction of the substrate surfaces to form a helical structure, and helical axes of the helical structure are substantially in parallel with the substrate surfaces. In the focal conic state, the liquid crystal layer 15 loses the selectivity of wavelengths to be reflected, and most of light rays incident on the layer are transmitted. Black can be displayed by the liquid crystal display element in the focal conic state by providing a light absorbing layer (not depicted) on a bottom surface of the bottom substrate 12 of the display section 6.

In the intermediate state that is a mixture of the planar and focal conic states, the ratio between reflected light and transmitted light is adjusted according to the ratio between the planar state and the focal conic state to vary the intensity of reflected light. Thus, intermediate gray levels can be displayed according to intensities of reflected light thus obtained.

As thus described, the amount of light reflected by the cholesteric liquid crystal can be controlled using a state of alignment of a helically twisted the liquid crystal molecules 63. The state of display of the liquid crystal display element utilizing the cholesteric liquid crystal is controlled using the state of alignment of the helically twisted the liquid crystal molecules 63.

A principle behind driving of the liquid crystal display element utilizing a cholesteric liquid crystal will now be described. When a predetermined high voltage is applied between the scan electrodes and the data electrodes to apply an intense electric field to the cholesteric liquid crystal, the helical structure of the liquid crystal molecules 63 is completely decomposed, and the liquid crystal enters a homeotropic state in which all liquid crystal molecules 63 follow the direction of the electric field. The planar state is obtained by abruptly nullifying the electric field in the homeotropic state.

The focal conic state is obtained as follows. A predetermined voltage lower than the above-described voltage is applied between the scan electrodes and the data electrodes to apply such a weak electric field that the helical structure of the liquid crystal molecules will not be decomposed, and the electric field is thereafter abruptly made zero. The focal conic state can be also obtained by applying an intense electric field as described-above to the cholesteric liquid crystal and thereafter slowly removing the electric field.

For example, the intermediate state that is a mixture of the planar state and the focal conic state can be obtained by applying a voltage lower than the voltage for obtaining the focal conic state between the scan electrodes and the data electrodes to apply an electric field to the liquid crystal layer 15 and thereafter nullifying the electric field abruptly. The liquid crystal display element displays information utilizing such a phenomenon.

Voltage response characteristics of the above-described cholesteric liquid crystal will now be outlined with reference to FIG. 25. FIG. 25 shows an example of voltage-reflectance characteristics of the cholesteric liquid crystal. The abscissa axis represents voltages (V) applied to the cholesteric liquid crystal, and the ordinate axis represents reflectances (relative values) of the cholesteric liquid crystal.

Let us assume that the cholesteric liquid crystal is initially in the planar state depicted as FIG. 25 (the planar state is represented by P and illustrated in FIG. 25 as a region of a high reflectance at the left side thereof). Then, when the pulse voltage is increased into a certain range, the voltage enters a band for driving the cholesteric liquid crystal toward the focal conic state (represented by FC). When the pulse voltage is further increased, the voltage enters a band in which the cholesteric liquid crystal is driven toward the planar state P again (toward a region of a high voltage depicted at the right side of the figure).

When the initial state is the focal conic state FC (which is illustrated as a region of a low reflectance at the left side of the figure), the pulse voltage gradually approaches a band for driving the cholesteric liquid crystal toward the planar state P as the pulse voltage increases.

In the planar state P, the cholesteric liquid crystal has a theoretical maximum reflectance of 50% because it reflects only either of right-handed and left-handed circularly polarized light rays and transmits the circularly polarized light rays polarized in the other direction.

Electronic paper may have a function of allowing a particular part of a display region (display area) to be rewritten (a partial rewrite). The applicant has filed a patent application related to a display element driving method which allows a high-speed partial screen rewrite (Japanese Patent Application No. 2005-099711).

FIGS. 26A and 26B are illustrations for explaining an example of the display element driving method according to the related art proposed in Japanese Patent Application No. 2005-099711. A liquid crystal display element 1 utilizing a cholesteric liquid crystal will be described below as an example of a display element driven according to the method. FIG. 26A shows a state of the liquid crystal display element 1 before a screen rewrite. FIG. 26B shows a state of the liquid crystal display element 1 after the screen rewrite. Depicted as FIGS. 26A and 26B, the liquid crystal display element 1 includes a display section 6 having a display area DR where images are displayed, a scan electrode driver IC (scan driver) 21 for driving a plurality of scan electrodes, and a data electrode driver IC (data driver) 22 for driving a plurality of data electrodes. The plurality of scan electrodes (not depicted) are formed in the display area DR, and the electrodes extend in the horizontal direction of FIGS. 26A and 26B. The plurality of data electrodes (not depicted) are formed in the display area DR, and the electrodes extend in the vertical direction of FIGS. 26A and 26B. Depicted as FIG. 26A, an image 100 is displayed in the display area DR before a partial rewrite.

Let us assume that a rewrite is performed in a partial rewrite region R0 of the initial image 100 depicted in FIG. 26A to display a partially rewritten image 200 depicted as FIG. 26B. According to the above-mentioned technique in the related art, as in the case of displaying a normal image, for example, scanning is performed at a normal speed over a region S12 defined in the scanning direction including the rewrite region R0 (or scan electrodes associated with the rewrite region R0 are scanned) is scanned to write an image (or to rewrite the existing image) instead of writing an image by scanning the entire range (represented by S10) in the scanning direction (all scan electrodes) at the normal speed. Other regions S11 and S13 defined in the scanning direction excluding the rewrite region R0 (scan electrodes which are not associated with the rewrite region R0: skipped region) are scanned at a higher speed to keep the original image unchanged.

In the scan operation of the scan driver 21, scanning is first performed in a high-speed mode in the region S11 which is not to be partially rewritten. When the region R0 to be partially rewritten is reached, scanning is performed at the normal scan speed to rewrite the image in the region. When the scanning of the rewrite region R0 is completed, the region S13 which is not to be partially rewritten is scanned in the high-speed mode. Thus, the process of partially rewriting an image is performed at a high operating speed.

For the skipped regions (S11 and S13) where writing is not performed, it is most, preferable to keep the voltage output from the data driver 22 off so as to prevent the existing images written in the regions from being adversely affected. However, the response of a liquid crystal becomes slower, at the higher speed it is scanned. Therefore, the scanning may alternatively be performed without turning off the voltage output off taking advantage of such a phenomenon.

FIG. 27 is a graph for explaining a shift of threshold characteristics of the cholesteric liquid crystal as a result of high-speed scanning. In the high-speed mode used for scanning the regions (S11 and S13) before and after the rewrite region R0, for example, a voltage of ±24 V or ±32 V is applied. Then, depicted as FIG. 27, a significant shift of (a shift toward high potentials) threshold characteristics occurs when the high-speed scanning is performed. Specifically, an operating threshold voltage of the cholesteric liquid crystal is shifted to a voltage higher than 32 V. Therefore, no change occurs in the state of alignment (the state of display) of the liquid crystal even when a voltage of, for example, ±24 V or ±32 V is applied. Thus, the original images in the skipped regions S11 and S13 can be kept unchanged only by scanning the regions at a high speed instead of turning the voltage output off.

As thus described, according to the display element driving method in the related art, a process of rewriting a part of an original image (a partial rewrite) can be performed at a high speed, and writing time can be consequently reduced.

However, the partial image rewriting process using the above-described display element driving method has a problem as described below. The problem will be described with reference to FIGS. 1, 2, and 28. FIG. 1 shows a state of the display section 6 of the liquid crystal display element before a partial rewrite. FIGS. 2 and 28 show a state of the display section 6 after the partial rewrite. FIGS. 1 and 2 are illustrations which will be referred to again in describing a first embodiment of the invention later.

Depicted as FIG. 1, an image 100 is displayed in the display area DR before the partial rewrite. The image 100 is displayed by scanning the scan electrodes associated with the entire display area DR at a normal speed (as schematically indicated by the downward arrow γ in FIG. 1) to rewrite the entire display area DR (the operation will be hereinafter referred to as “full rewrite”). The image 100 has a background color A.

When the partial region R0 of the display area DR is to be rewritten into an image 120 to rewrite the image 100 into an image 200 depicted as FIG. 2, the scan electrodes in the region S11 are first scanned at a high speed. Then, the scan electrodes in the region S12 including the region R0 are scanned at a normal speed (as schematically indicated by the downward arrow α in FIG. 2). Thus, rewriting is performed in the region S12. The region R0 included in the region S12 is rewritten into an image 120, and a region R11 in the region S12 outside the region R10 is rewritten so as to maintain the image displayed before the partial rewrite. Next, the scan electrodes in the region S13 are scanned at the high speed. A voltage lower then the operating threshold voltage is applied to the liquid crystal in the regions S11 and S13. Therefore, no image rewrite takes place in the regions S11 and S13. As thus described, an image 200 depicted as FIG. 2 is displayed in the display area DR. The same background color A as in the regions S11 and S13 is displayed in the region R11.

However, the above-described rewriting method has a problem in that a color difference may occur between the color in the regions S11 and S13 and the color in the region R11 depicted as FIG. 28. FIG. 28 despicts a state of the display section 6 after a partial rewrite which has resulted in a color difference. Depicted as FIG. 28, when there is a color difference, an image 400 is displayed in the display area DR instead of the image 200. In the region R11, the same background color A as in the regions S11 and S13 may be displayed. In the image 400, however, there is a color difference between the background color A in the regions S11 and S13 and a background color B in the region R11. In this case, the display quality of the image as a whole is degraded, and the image may not be displayed satisfactorily.

Such a color difference is generated when there is a significant difference between the temperature at which a full rewrite is performed to rewrite the entire display area DR into the image 100 and the temperature at which the region is partially rewritten. Solid-state properties of the cholesteric liquid crystal and the response of the same to a pulse voltage depend on the temperature thereof. Therefore, when there is a great temperature difference, the response of the liquid crystal to a voltage at the time of a full rewrite is significantly different from the response of the liquid crystal to a voltage at the time of a partial rewrite. The regions S11 and S13 are rewritten at the time of the full rewrite and not rewritten when the partial rewrite is performed. On the contrary, the region R11 is rewritten at the time of a partial rewrite. Therefore, the region has a color difference.

Such a color difference may occur also when there is a significant difference between the time required for a full rewrite and the time required for a partial rewrite. When a partial rewrite follows a full rewrite with an interval having a predetermined duration or longer, a color difference similar to that attributable to a temperature difference can occur even if the temperature is the same at the time of the full rewrite and the time of the partial rewrite. A cause of the color difference is considered that a considerable period of time is required for liquid crystal molecules in the vicinity of interfaces to be completely stabilized after the application of a voltage.

The above-described problem can occur not only in liquid crystal display elements utilizing cholesteric liquid crystals but also in other types of display elements having the property of memorizing a state of display. For example, such display elements include display elements utilizing electrophoresis or electron flow dividers.

### SUMMARY

According to espets of an embodiment, there is a display element including, a display section having a light reflector and a display area on which an image is displayed based on the state of the light reflector, a data storage portion for storing first environmental data when a first image rewrite is performed to rewrite the entire display area into a first image and second environmental data when a second image rewrite is performed to rewrite a first region that is a part of the display area into a second image, and an image rewrite control portion for selecting a rewrite of the entire display area or a rewrite of the second region that is a part of the display area including the first region when the second image rewrite is performed based on the first and second environmental data and/or the second image.

The above invention is characterized in that the image rewrite control portion selects the rewrite of the entire display area when a color difference between the color of the second region after the second image rewrite and the color of the display area excluding the second region is greater than a predetermined value and selects the rewrite of the second region when the color difference is equal to or smaller than the predetermined value. The above invention is characterized in that the predetermined value of color difference is substantially a color difference ΔE*ab of 3 in an L*a*b* color space.

The above invention is characterized in that the first environmental data includes a temperature of the neighborhood of the display section measured when the first image rewrite is performed, the second environmental data includes a temperature of the neighborhood of the display section measured when the second image rewrite is performed, and the image rewrite control portion selects the rewrite of the entire display area in performing the second image rewrite when a difference between the temperatures measured at the time of the first image rewrite and the second image rewrite is equal to or greater than a predetermined value.

The above invention is characterized in that the first environmental data includes time at which the first image rewrite is performed, the second environmental data includes time at which the second image rewrite is performed, and the image rewrite control portion selects the rewrite of the entire display area in performing the second image rewrite when a difference between the time of the first image rewrite and the time of the second image rewrite is equal to or greater than a predetermined value. The above invention is characterized in that the display section includes a plurality of first electrodes, a plurality of second electrodes disposed to intersect the plurality of first electrodes, and a plurality of pixels each of which is disposed at an intersection between the plurality of first and second electrodes, and the light reflector is driven by applying a voltage to the plurality of first and second electrodes.

The above invention is characterized in that the second region is a region formed by the plurality of first electrodes on which the plurality of pixels associated with the second image are disposed.

The above invention is characterized in that the image rewrite control portion selects the rewrite of the second region in performing the second image rewrite regardless of the first and second environmental data when the first region coincides with the second region and the gray levels of the plurality of pixels in the second region are all different from the gray levels of the plurality of pixels in the display area excluding the second region.

The above invention is characterized in that it further includes a driving section for scanning the plurality of first electrodes in a predetermined order and applying a voltage to the plurality of first and second electrodes to drive the light reflector and in that the driving section scans all of the plurality of first electrodes when the second image rewrite is performed and applies a voltage to the plurality of first and second electrodes such that a voltage applied to the light reflector becomes equal to or lower than a threshold voltage at which the light reflector responds while scanning the plurality of first electrodes in the display area excluding the second region.

The above invention is characterized in that the light reflector has memory characteristics.

The above invention is characterized in that the light reflector is a liquid crystal which forms a cholesteric phase.

The above-described object is achieved by electronic paper including a display element according to the above invention.

The above-described object is achieved by an electric terminal including a display element according to the above invention.

The above-described object is achieved by an image rewriting method for a display element having a display section including a light reflector and a display area in which an image is displayed based on the state of the light reflector, the method comprising, the steps of storing first environmental data when a first image rewrite is performed to rewrite the entire display area into a first image and second environmental data when a second image rewrite is performed to rewrite a first region that is a part of the display area into a second image, and selecting a rewrite of the entire display area or a rewrite of the second region that is a part of the display area including the first region when the second image rewrite is performed based on the first and second environmental data and/or the second image.

The above invention is characterized in that an image rewrite control portion selects the rewrite of the entire display area when a color difference between the color of the second region after the second image rewrite and the color of the display area excluding the second region is greater than a predetermined value and selects the rewrite of the second region when the color difference is equal to or smaller than the predetermined value. The above invention is characterized in that the predetermined value of color difference is substantially a color difference ΔE*ab of 3 in an L*a*b* color space.

The above invention is characterized in that the first environmental data includes a temperature of the neighborhood of the display section measured when the first image rewrite is performed, the second environmental data includes a temperature of the neighborhood of the display section measured when the second image rewrite is performed, and the rewrite of the entire display area is selected in performing the second image rewrite when a difference between the temperatures measured at the time of the first image rewrite and the second image rewrite is equal to or greater than a predetermined value.

The above invention is characterized in that the first environmental data includes time at which the first image rewrite is performed, the second environmental data includes time at which the second image rewrite is performed, and an image rewrite control portion selects the rewrite of the entre display area in performing the second image rewrite when a difference between the time of the first image rewrite and the time of the second image rewrite is equal to or greater than a predetermined value.

The above invention is characterized in that the display section includes a plurality of first electrodes, a plurality of second electrodes disposed to intersect the plurality of first electrodes, and a plurality of pixels each of which is disposed at an intersection between the plurality of first and second electrodes; and the light reflector is driven by applying a voltage to the plurality of first and second electrodes.

The above invention is characterized in the second region is a region formed by the plurality of first electrodes on which the plurality of pixels associated with the second image are disposed.

The above invention is characterized in that the rewrite of the second region is selected in performing the second image rewrite regardless of the first and second environmental data when the first region coincides with the second region and the gray levels of the plurality of pixels in the second region are all different from the gray levels of the plurality of pixels in the display area excluding the second region.

The above invention is characterized in that it includes the step of scanning the plurality of first electrodes in a predetermined order and applying a voltage to the plurality of first and second electrodes to drive the light reflector; and scanning all of the plurality of first electrodes when the second image rewrite is performed and applying a voltage to the plurality of first and second electrodes such that a voltage applied to the light reflector becomes equal to or lower than a threshold voltage at which the light reflector responds while scanning the plurality of first electrodes in the display area excluding the second region.

The invention makes it possible to provide a display element and an image rewriting method for the display element which can achieve high display quality and to provide electronic paper and an electronic terminal utilizing the display element.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an illustration showing a state of a display section 6 of a liquid crystal display element according to a first embodiment of the invention observed before an image rewrite;

FIG. 2 is an illustration (1) showing a state of the display section 6 of the liquid crystal display element according to the first embodiment of the invention observed after the image rewrite;

FIG. 3 is an illustration (2) showing a state of the display section 6 of the liquid crystal display element according to the first embodiment of the invention observed after the image rewrite;

FIG. 4 is an illustration (3) showing a state of the display section 6 of the liquid crystal display element according to the first embodiment of the invention observed after the image rewrite;

FIG. 5 is a graph showing an example of a relationship between temperatures at the time of an image rewrite and color differences;

FIG. 6 is a graph showing an example of changes in a color difference ΔE*ab attributable to the lapse of time;

FIG. 7 is a block diagram of a liquid crystal display element 1 according to the first embodiment of the invention showing a circuit configuration thereof;

FIG. 8 is a sectional view schematically showing an example of the display section 6 of the liquid crystal display element 1;

FIG. 9 is a flow chart showing an image rewriting method for a second image rewrite performed in the liquid crystal display element 1 according to the first embodiment of the invention;

FIG. 10 is an illustration for explaining another problem of the display element driving method according to the related art proposed in JP-A-2005-099711;

FIG. 11 is an illustration for explaining the principle of a display element driving method according to a second embodiment of the invention;

FIG. 12 is a block diagram of a liquid crystal display element 101 according to the second embodiment of the invention showing a circuit configuration thereof;

FIG. 13 is an illustration for exemplifying a display element driving method according to the related art proposed in Pamphlet of International Patent Publication No. 2005/024774;

FIG. 14 is an illustration for explaining a problem in an example of the display element driving method according to the related art proposed in Pamphlet of International Patent Publication No. 2005/024774;

FIG. 15 is an illustration (1) for explaining the principle of a display element driving method according to a third embodiment of the invention;

FIG. 16 is an illustration (2) for explaining the principle of the display element driving method according to the third embodiment of the invention;

FIG. 17 is a block diagram of a liquid crystal display element 201 according to the third embodiment of the invention showing a circuit configuration thereof;

FIG. 18 is an illustration for explaining an example of a display element driving method according to the third embodiment of the invention;

FIG. 19 is an illustration for explaining a modification of the display element driving element depicted in FIG. 18;

FIG. 20 is an illustration (1) for explaining another example of the display element driving method according to the third embodiment of the invention;

FIG. 21 is an illustration (2) for explaining the another example of the display element driving method according to the third embodiment of the invention;

FIG. 22 is an illustration (1) for explaining still another example of the display element driving method according to the third embodiment of the invention;

FIG. 23 is an illustration (2) for explaining the still another example of the display element driving method according to the third embodiment of the invention;

FIGS. 24A and 24B are an illustration for explaining states of alignment of a cholesteric liquid crystal;

FIG. 25 is a graph showing an example of voltage-reflectance characteristics of a cholesteric liquid crystal;

FIGS. 26A and 26B are illustrations for explaining an example of a display element driving method according to the related art proposed in JP-A-2005-099711;

FIG. 27 is a graph for explaining a shift of threshold characteristics of a cholesteric liquid crystal as a result of high-speed scanning; and

FIG. 28 is an illustration for explaining a problem of a method of partially rewriting an image utilizing a display element driving method according to the related art proposed in JP-A-2005-099711.

### DESCRIPTION OF EMBODIMENTS

### First Embodiment

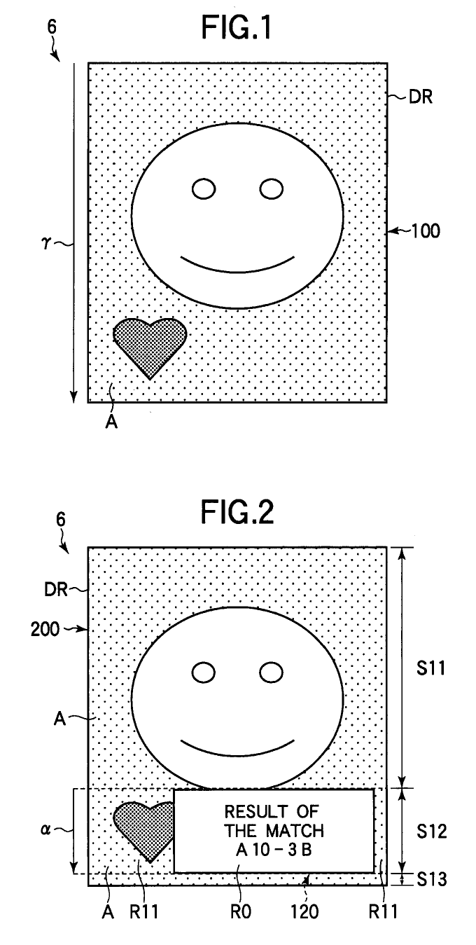

A description will now be made with reference to FIGS. 1 to 9 on a display element, an image rewriting method for the display element, and electronic paper and an electronic terminal utilizing the display element according to a first embodiment of the invention. First, the principle of the image rewriting method for the display element according to the present embodiment will be described with reference to FIGS. 1 to 6. A liquid crystal display element utilizing a cholesteric liquid crystal will be described as an exemplary display element according to the present embodiment.

FIG. 1 shows a state of a display section 6 of the liquid crystal display element before an image rewrite. Depicted as FIG. 1, the display section 6 has a display area DR for displaying an image. The display section 6 includes a pair of substrates, i.e., top and bottom substrates (not depicted) disposed opposite to each other and a liquid crystal layer enclosed between the substrates. The liquid crystal layer includes a cholesteric liquid crystal (light reflector). An image is displayed in the display area DR based on the state of the cholesteric liquid crystal.

A plurality of scan electrodes (or first electrodes which are not depicted) in the form of strips are formed in parallel with each other on the side of the top substrate facing the liquid crystal layer, the electrodes extending in the horizontal direction of FIG. 1. A plurality of data electrodes (or second electrodes which are not depicted) are formed in parallel with each other on the side of the bottom substrate facing the liquid crystal layer, the electrodes being disposed to intersect the plurality of scan electrodes and extending in the vertical direction of FIG. 1. Each of regions where the scan electrodes and the data electrodes intersect each other constitutes a pixel. A pixel is disposed at each of intersections between the scan electrodes and the data electrodes, and the pixels are disposed in the form of a matrix in the display area DR. The cholesteric liquid crystal is driven by applying a voltage between the scan electrodes and the data electrodes.

Depicted as FIG. 1, an image (first image) 100 is displayed in the display area DR before an image rewrite. The image 100 is displayed by scanning the scan electrodes in the entire display area DR (as schematically indicated by the downward arrow γ in FIG. 1) to rewrite the display area DR as a whole (the operation will be hereinafter referred to as “a full rewrite”). The image 100 has a background color A.

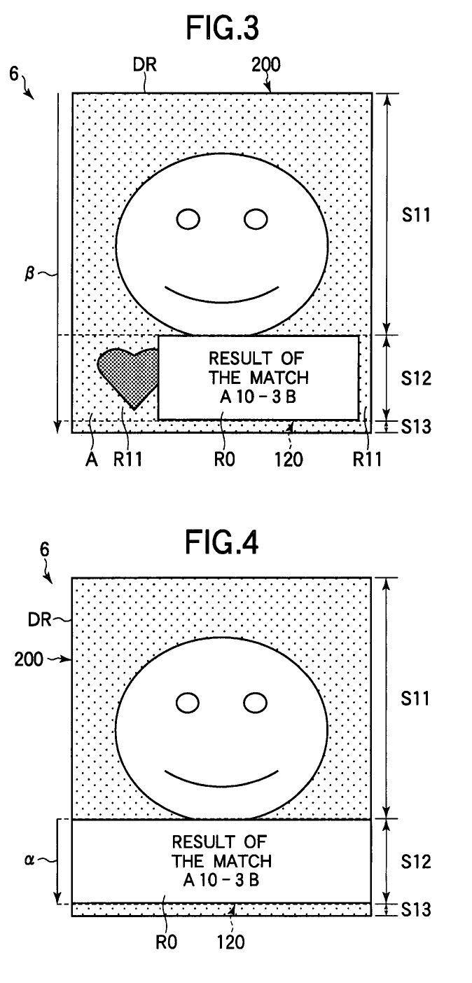

FIGS. 2 and 3 show a state of the display section 6 after the image rewrite. Depicted as FIG. 2, an image 200 is displayed in the display area DR after the image rewrite. The image 200 is displayed by rewriting a partial region (a first region) R0 of the display area DR into an image 120.

According to the image rewriting method of the present embodiment, the temperature of the neighborhood of the display section 6 measured when the entire display area DR is rewritten into the image 100 (the operation will be hereinafter referred to as “a first image rewrite”) and the time of the rewriting operation (first environmental data) is stored. Further, the temperature of the neighborhood of the display section 6 measured when the region R0 is rewritten into the image 120 (the operation will be hereinafter referred to as “a second image rewrite”) and the time of the rewriting operation (second environmental data) is stored. Based on the temperature and time associated with the first and second image rewrites and the position and the size of the image 120, selection is made as to the mode of the second image rewrite, i.e., whether the display area DR is to be entirely rewritten by the second image rewrite or whether a region (second region) S12 that is apart of the display area DR including the region R0 is to be rewritten (the operation will be referred to as “a partial rewrite” in the description of the present embodiment). The region S12 is a region formed by a plurality of scan electrodes, in which pixels associated the image 120 are disposed.

When both of a temperature difference and a time difference between the first image rewrite and the second image rewrite are equal to or smaller than predetermined values, the region S12 including the region R0 is rewritten, and regions S11 and S13 which do not include the region R0 are not rewritten. That is, a part of the display area DR is rewritten. In this case, depicted as FIG. 2, the scan electrodes in the region S11 are first sequentially scanned at a high speed in a top-to-bottom direction in FIG. 2. Next, the scan electrodes in the region S12 including the region R0 are sequentially scanned at a normal speed in the top-to-bottom direction in FIG. 2 (as schematically indicated by the downward arrow α in FIG. 2). Thus, the region S12 is rewritten. The region R0 included in the region S12 is rewritten into an image 120, and a region R11 that is the region of the region S12 excluding the region R0 is rewritten into the same image as displayed before the writing. Next, the scan electrodes in the region S13 are sequentially scanned at the high speed in the top-to-bottom direction in FIG. 2. A voltage equal to or lower than an operating threshold voltage is applied to the liquid crystal in the regions S11 and S13. Therefore, no image rewrite takes place in the regions S11 and S13. As a result of the above-described rewriting process, an image 200 is displayed in the display area DR depicted as FIG. 2.

The regions S11 and S13 are rewritten at the first image rewrite and are not rewritten at the second image rewrite. On the contrary, the region R11 is rewritten at the second rewrite. However, since both of the temperature difference and the time difference between the first image rewrite and the second image rewrite are equal to or lower than predetermined values, there is no appreciable color difference between the color of the region R11 and the color of the regions S11 and S13. Substantially the same background color A as in the regions S11 and S13 is displayed in the region R11. Therefore, in this case, the display quality of the image as a whole is not degraded, and the image can be displayed satisfactorily.

When the temperature difference between the first image rewrite and the second image rewrite is equal to or greater than the predetermined value, the entire display area DR is rewritten at the second image rewrite even in the case that the partial region R0 of the display area DR is rewritten. The entire display area DR is also rewritten at the second image rewrite also when the time difference between the first image rewrite and the second image rewrite is equal to or greater than the predetermined value.

In this case, depicted as FIG. 3, the scan electrodes in the entire display area DR are scanned at the normal speed (as schematically indicated by the downward arrow β in FIG. 3). Since all of the regions S11, S12, and S13 are rewritten at the second image rewrite, there is no color difference between the region R11 and the regions S11 and S13. Thus, even when the temperature difference or the time difference is equal to or greater than the predetermined value, the display quality of the image as a whole is not degraded, and the image can be satisfactorily displayed.

FIG. 4 shows a state of the display section 6 after the image rewrite. A color difference between the region S12 and the regions S11 and S13 is not a problem when the region R0 where a partial rewrite is performed coincides with the region S12 and the gray levels of the pixels in the region S12 are all different from the gray levels of the pixels in the regions other than the region S12, i.e., the regions S11 and S13. In such a case, therefore, the region S12 including the region R0 is rewritten at the second image rewrite, and the regions S11 and S13 which do not include the region R0 are not rewritten.

In this case, depicted as FIG. 4, the scan electrodes in the region S11 are first scanned at a high speed. Then, the scan electrodes in the region S12 including the region R0 are scanned at the normal speed (as schematically indicated by the downward arrow α in FIG. 4). Thus, the region S12 is rewritten into an image 120. Next, the scan electrodes in the region S13 are scanned at a high speed. A voltage equal to or lower than the operating threshold voltage is applied to the liquid crystal in the regions S11 and S13. Therefore, no image rewrite takes place in the regions S11 and S13. As a result of the above-described writing process, an image 200 is displayed in the display area DR depicted as FIG. 4.

As described above, according to the present embodiment, there is no color difference between the region R11 and the regions S11 and S13 even when the temperature difference or the time difference is equal to or higher than the predetermined value. Therefore, even when the temperature difference or the time difference is equal to or higher than the predetermined value, the display quality of an image as a whole is not degraded, and the image can be displayed satisfactorily.

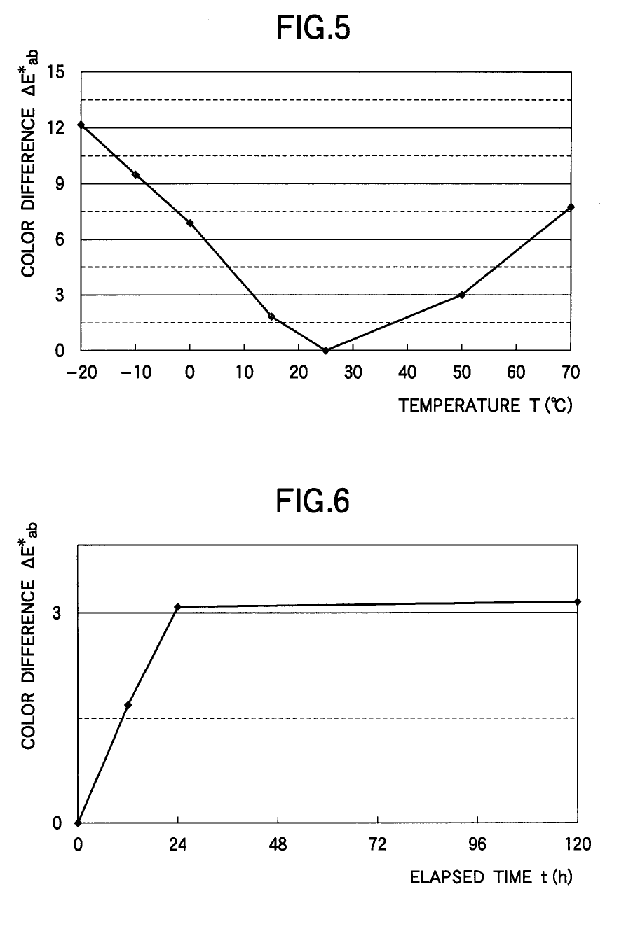

FIG. 5 is a graph showing an example of a relationship between temperatures and color differences at the time of an image rewrite. The abscissa axis of the graph represents temperatures T (° C.) of the neighborhood of the display section 6 when an image rewrite is performed. The ordinate axis represents color differences ΔE*ab in an L*a*b uniform color space. A color difference ΔE*ab depicted in FIG. 5 is a color difference between the color of an image obtained by an image rewrite performed based on predetermined image data at a temperature of 25° C. and the color of the image obtained by the image rewrite performed based on the image data at a temperature T (° C.).

Depicted as FIG. 5, when there is no temperature difference between the two image rewrites or when the temperature T is 25° C., the color difference ΔE*ab is 0. The color difference ΔE*ab becomes greater, the greater the temperature difference between the two image rewrites. For example, when the temperature T is 50° C., the color difference ΔE*ab is approximately 3. Similarly, when the temperature T is 10° C., the color difference ΔE*ab is approximately 3. The relationship between temperature differences and color differences ΔE*ab depicted in FIG. 5 is merely an example, and the relationship depends on liquid crystal materials, panel structures or the like. There is a set of generalized indices for color differences ΔE*ab depicted as Table 1 (the table has been cited from http://www.nsg-ntr.com/TIME/opt-01.htm).

TABLE 1

| Color differences ΔE*ab | Sensual representations |
|---|---|
| 0 to 0.5 | traces of color differences |
| 0.5 to 1.5 | slight color differences |
| 1.5 to 3.0 | noticeable color differences |
| 3.0 to 6.0 | appreciable color differences |
| 6.0 to 12.0 | much color differences |
| more than 12.0 | very much color differences |

Table 1 depicts a sensual representation of color differences ΔE*ab in each range of color difference values ΔE*ab. Depicted as Table 1, color differences ΔE*ab having values in the range from 0 to 0.5 are represented to be traces of color differences. Color differences ΔE*ab having values in the range from 0.5 to 1.5 are represented to be slight color differences. Color differences ΔE*ab having values in the range from 1.5 to 3.0 are represented to be noticeable color differences. Color differences ΔE*ab having values in the range from 3.0 to 6.0 are represented to be appreciable color differences. Color differences ΔE*ab having values in the range from 6.0 to 12.0 are represented to be great (much) color differences. Color differences ΔE*ab having values greater than 12.0 are represented to be very great (very much) color differences.

An image can be satisfactorily displayed by, after the second rewrite operation, keeping the color difference ΔE*ab between the color of the region R11 and the color of the regions S11 and S13 at 3.0 or less or, more preferably, 1.5 or less. Therefore, according to the image rewriting method for a display element of the present embodiment, a rewrite of the entire display area DR is selected at the second image rewrite, for example, when the color difference ΔE*ab is greater than 3.

For example, let us assume that a first image rewrite is performed at a temperature of 25° C. and that a second image rewrite is performed at a temperature of 35° C. Then, the color difference ΔE*ab between the color of the region R11 and the color of the regions S11 and S13 is less than 1.5 as apparent from FIG. 5. At this time, a viewer will perceive substantially no color difference from an image which has been partially rewritten at a second image rewrite.

At the same time, let us now assume that a first image rewrite is performed at a temperature of 25° C. and that a second image rewrite is performed at a temperature of 10° C. Then, the color difference ΔE*ab between the color of the region R11 and the color of the regions S11 and S13 is 3 or more as apparent from FIG. 5. At this time, the entire display area DR may be rewritten at the second image rewrite.

FIG. 6 is a graph showing an example of changes in a color difference ΔE*ab attributable to the lapse of time. The abscissa axis of the graph represents elapsed times (time differences) t(h) between a first image rewrite and a second image rewrite. The ordinate axis represents color differences ΔE*ab between the color of the region R11 and the color of the regions S11 and S13 observed when a partial rewrite is performed at the second image rewrite. The first and second image rewrites are performed under the same temperature condition. The relationship between the elapsed times t and the color differences ΔE*ab depicted in FIG. 6 is merely an example, and the relationship depends on liquid crystal materials, panel structures or the like.

Depicted as FIG. 6, when there is no time difference between the first and second image rewrites or when the elapsed time t is 0(h), the color difference ΔE*ab is 0. The color difference ΔE*ab monotonously increases with the increase in the elapsed time t. When the elapsed time t is in the excess of about 12 hours, the color difference ΔE*ab is 1.5 or more. When the elapsed time t is about 24 hours, the color difference ΔE*ab is 3.0 or more. When the elapsed t is in the excess of 24 hours, the color difference ΔE*ab stays substantially unchanged.

Therefore, when the elapsed time t is, for example, 24 hours or more, it is preferable to perform a full rewrite even if it is required to rewrite only a part of the display area DR. When the elapsed time t is less than 24 hours, a viewer will perceive substantially no color difference from an image which has been partially rewritten.

In the above description, conditions for temperature differences and time differences have been discussed independently of each other, the logical product of those conditions is applied to the second image rewrite. For example, when the first image rewrite is performed at a temperature of 25° C., the second image rewrite may include a partial rewrite provided that the elapsed time t is less than 24 hours and that the temperature at the time of the second image rewrite is in the range from 12 to 50° C. When either of the conditions on the temperature difference and the time difference is not satisfied, the entire display area DR is rewritten at the second image rewrite even if only a part of the display area DR is to be rewritten.

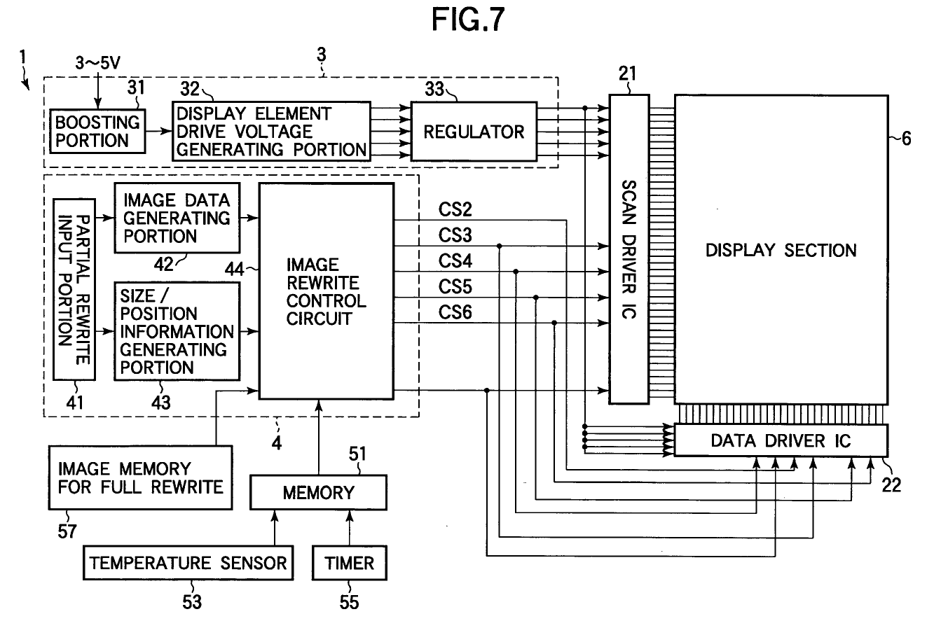

FIG. 7 is a block diagram of a liquid crystal display element 1 according to the present embodiment showing a circuit configuration thereof. Depicted as FIG. 7, the liquid crystal display element 1 includes a power supply circuit 3, a control circuit 4, a display section 6, a scan driver IC 21, and a data driver IC 22. The liquid crystal display element 1 also includes a memory (data storage portion) 51, a temperature sensor 53, a timer 55, and an image memory 57 for total rewriting.

Depicted as FIG. 7, the power supply circuit 3 includes a boosting portion 31, a display element drive voltage generating portion (voltage generating portion) 32, and a regulator 33. For example, the boosting portion 31 receives an input voltage of about +3 to +5 V from a battery, boosts the voltage into a voltage for driving the display section 6, and supplies the resultant voltage to the voltage generating portion 32. The voltage generating portion 32 generates voltages required for the scan driver IC 21 and the data driver IC 22, respectively. The regulator 33 stabilizes the voltages from the voltage generating portion 32 and supplies them to the scan driver IC 21 and the data driver IC 22.

The temperature sensor 53 detects the temperature of the neighborhood of the display section 6 when a first image rewrite is performed (first environmental data) and when a second image rewrite is performed (second environmental data). The timer 55 measures the time at which the first image rewrite is performed (first environmental data) and the time at which the second image rewrite is performed (second environmental data). Temperature information and time information are stored in the memory 51 and are memorized in the memory 51.

The control circuit 4 includes a partial rewrite input portion 41, an image data generating portion 42, a size/position information generating portion 43, and an image rewrite control circuit (image rewrite control portion) 44. The control circuit 4 carries out calculations of image data and control signals supplied from outside. The control circuit 4 also supplies appropriate signals to the scan driver IC 21 and the data driver IC 22.

The partial rewrite input portion 41 recognizes the second image rewrite is an image rewrite for rewriting a region R0 that is a part of the display area DR (a partial image rewrite) from image data and the control signals supplied from outside. The image data generating portion 42 generates image data for the region R0 that is the part to be rewritten, and the size/position information generating portion 43 generates size/position information of the region R0 that is the part to be rewritten (information on the position of the region R0 to be rewritten in the screen). The image data and the size/position information of the region R0 to be rewritten is input to the image rewrite control circuit 44. Image data of an image 100 (image data to be used at the first image rewrite) is stored in the image memory 57 for total rewriting.

When the second image rewrite is performed, the image rewrite control circuit 44 receives information on the temperatures and times when the first and second image rewrites are performed from the memory 51. Based on the temperature and time information of the first and second image rewrites and the information on the size/position of the region R0, the image rewrite control circuit 44 selects a mode for the second image rewrite, i.e., a rewrite of the entire display area DR or a rewrite of a region S12 that is a part of the display area DR including the region R0.

Image rewrite control circuit 44 selects the rewriting of the entire display area DR at the second image rewrite when the temperature difference between the first and second image rewrites is equal to or greater than a predetermined reference value, e.g., 5° C. Image rewrite control circuit 44 selects the rewriting of the entire display area DR at the second image rewrite when the time difference between the first and second image rewrites is equal to or greater than a predetermined reference value, e.g., 24 hours. In order to display an image with a smaller color difference, the image rewrite control circuit 44 may select the rewriting of the entire display area DR when the time difference is 12 hours or more.

When the region R0 that is the part to be rewritten coincides with the region S12 and the gray levels of the pixels in the region S12 are all different from the gray levels of the pixels in display regions S11 and S13 outside the display region S12, the image rewrite control circuit 44 selects rewriting the region S12 including the region R0 is selected at the second image rewrite regardless of the temperature difference and the time difference.

The image rewrite control circuit 44 outputs a data fetching clock CS2, a pulse polarity control signal CS3, a frame start signal CS4, a data latch/scan shift signal CS5, and a driver output cut-off signal CS6.

The data fetching clock CS2 is a signal supplied to the data driver IC 22 for sequentially fetching data for one line. When a partial rewrite is performed at the second image rewrite, the data for one line is data for the region S12 which is to be rewritten. The pulse polarity control signal CS3 is a signal for exercising control to invert the polarity of a pulse voltage applied to the display section 6. The frame start signal CS4 is a signal indicating the beginning of an image of one frame. The data latch/scan shift signal CS5 is a signal for controlling synthesizing lines on which data is stored by the data driver 22 and lines selected by the scan driver 21. The driver output cut-off signal CS6 is a signal for cutting off a driver output from the data driver 22 or the scan driver 21.

When the rewriting of the entire display area DR at the second image rewrite is selected, the image rewrite control circuit 44 synthesizes the image data of the image 100 received from the image memory 57 for total rewriting and the image data of the region R0 input from the image data generating portion 42 to generate image data for rewriting the entire display area DR to display the image 200 in the display area DR.

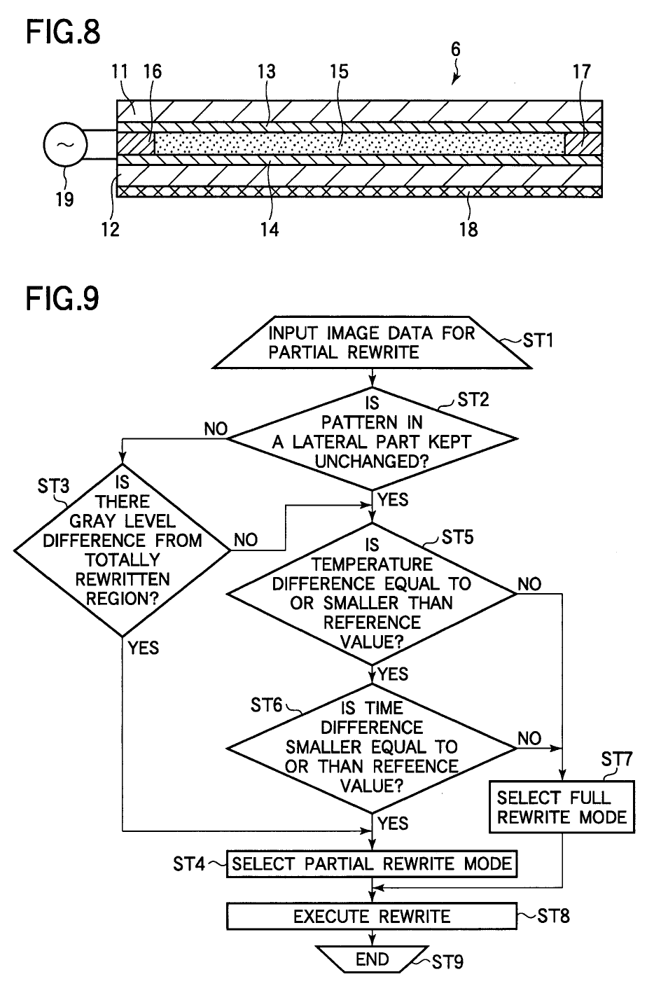

FIG. 8 is a sectional view schematically showing an example of the display section 6 of the liquid crystal display element 1. In FIG. 8, reference numerals 11 and 12 represent film substrates (top and bottom substrates). Reference numerals 13 and 14 represent transparent electrodes (which are made of, for example, an ITO). Reference numeral 15 represents a liquid crystal composition (liquid crystal layer). Reference numerals 16 and 17 represent seal materials. Reference numeral 18 represents a light-absorbing layer. Reference numeral 19 represents a driving circuit.

The display section 6 includes the liquid crystal composition 15, and the transparent electrodes 13 and 14 are formed on inner surfaces (surfaces between which the liquid crystal composition 15 is enclosed) of the transparent film substrates 11 and 12, respectively, the electrodes extending perpendicularly to each other. Specifically, a plurality of scan electrodes 13 and a plurality of data electrodes 14 are formed in the form of a matrix on the respective film substrates 11 and 12 which are disposed opposite to each other. Although the scan electrodes 13 and the data electrodes 14 are drawn in FIG. 8 as if they are in parallel with each other, it is needless to say that the electrodes are disposed for example, such that a plurality of data electrodes 14 intersect one scan electrode 13. For example, each of the film substrates 11 and 12 has a thickness of about 0.2 mm, and the layer of the liquid crystal composition 15 has a thickness of about 3 to 6 μm. For convenience, the proportions of the thicknesses are ignored in the illustration.

Each of the groups of electrodes 13 and 14 is preferably coated with an insulating thin film or alignment stabilizing film. A visible light absorbing layer 18 may be provided as occasion demands on an outer surface (bottom surface) of the substrate located on the side of the element opposite to a light-entering side thereof (bottom substrate 12). In the present embodiment, the liquid crystal composition 15 is a cholesteric liquid crystal which exhibits a cholesteric phase at room temperature.

The seal materials 16 and 17 are provided for enclosing the liquid crystal composition 15 between the film substrates 11 and 12. The driving circuit 19 applies a predetermined pulsed voltage to the electrodes 13 and 14. The driving circuit 19 is formed by the scan driver IC 21 and the data driver IC 22.

Both of the film substrates 11 and 12 have translucency, and at least either of the pair of substrates may have translucency to be used in the liquid crystal display element 1 of the present embodiment. Glass substrates are exemplary substrates having translucency, and film substrates made of flexible resins such as PET and PC may be used as alternatives to glass substrates. The electrodes 13 and 14 are typically made of an ITO (indium tin oxide), and other materials such as transparent conductive films made of an IZO (indium zinc oxide) or photo-conductive films made of amorphous silicon may alternatively be used.

In the liquid crystal display element depicted in FIG. 8, the plurality of transparent electrodes 13 and 14 in the form of strips extending in parallel with each other are formed on inner surfaces of the transparent film substrates 11 and 12, and the groups of electrodes 13 and 14 are provided opposite to each other such that they intersect each other when viewed in the direction perpendicular to the substrates.

The liquid crystal display element of the present embodiment may be formed with an insulating thin film which prevents shorting between the electrodes or which serves as a gas barrier layer having the function of improving the reliability of the liquid crystal display element. A polyimide resin or an acryl resin may be used as the alignment stabilizing films. The alignment stabilizing films for coating the electrodes 13 and 14 may also serve as insulating thin films.

In the liquid crystal display element of the present embodiment, spacers may be provided between the pair of substrates to keep the gap between the substrate uniform. For example, spherical bodies made of a resin or inorganic oxide may be used as the spacers. Fixed spacers coated with a thermoplastic resin on the surface thereof may alternatively be used with preferable results.

For example, the liquid crystal composition 15 may be a cholesteric liquid crystal obtained by adding a chiral additive to a nematic liquid crystal composition up to 10 to 40% by weight. The amount of the chiral additive is a value expressed on an assumption that the amounts of the nematic liquid crystal component and the chiral additive total to 100% by weight.

While various types of known nematic liquid crystals may be used, a material having dielectric constant anisotropy of 20 or more is preferable from the point of view of the driving voltage. Specifically, a relatively low driving voltage may be used when the cholesteric liquid crystal has dielectric constant anisotropy of 20 or more. Further, the dielectric constant anisotropy (Δε) of the cholesteric liquid crystal composition is preferably in the range from 20 to 50. When the dielectric constant anisotropy is substantially in this range, general-purpose drivers may be used as the scan driver IC 21 and the data driver IC 22.

The cholesteric liquid crystal preferably has refractive index anisotropy (Δn) in the range from 0.18 to 0.24. The cholesteric liquid crystal has an undesirably low reflectance in the planar state when the refractive index anisotropy is lower than the range. When the refractive index anisotropy is in the excess of the range, significant scattered reflections occur in the focal conic state, and the cholesteric liquid crystal accordingly has high viscosity which results in a lower speed of response. The liquid crystal preferably has a thickness in the range from about 3 μm to about 6 μm. When the thickness is smaller than the range, the liquid crystal has an undesirably low reflectance in the planar state. A thickness in the excess of the range is also undesirable because an excessively high driving voltage will be required.

An image rewriting method for the display element of the present embodiment will now be described with reference to FIGS. 7 and 9. FIG. 9 is a flow chart showing an image rewriting method for a second image rewrite performed in the liquid crystal display element 1 of the present embodiment.

First, image data of the region R0 that is the subject of a partial rewrite is input from the image data generating portion 42 to the image rewrite control circuit 44 (step ST1; input of image data for partial rewrite). Next, based on the image data, the image rewrite control circuit 44 determines whether the pattern of an image in a part located laterally to the region R0 is kept unchanged or not or whether the region R0 coincides with a region S12 (step ST2). When it is determined that the pattern of the image of the part lateral to the region R0 is not kept unchanged, the image rewrite control circuit 44 determines whether the gray levels of the pixels in the region R0 are all different from the gray levels of the pixels in display regions S11 and S13 outside the region R0 (step ST3). When the pixels are all different, the image rewrite control circuit 44 selects a rewrite of the region S12 which is a part of the display area DR at a second image rewrite (step ST4; selection of a partial rewrite mode).

When it is determined at step ST2 that the pattern of the image of the part located laterally to the region R0 is kept unchanged or when it is determined at step ST3 that there is gray level(s) identical between the pixels in the region R0 and the pixels in the regions S11 and S13 outside the region R0, the image rewrite control circuit 44 determines whether a difference between the temperatures at which the first and second image rewrites are performed is equal to or less than a predetermined reference value (e.g., 5° C.) based on information on the temperatures at the first and second image rewrites received from the image memory 57 for total rewriting (step ST5).

When it is determined at step ST5 that the temperature difference is equal to or smaller than the reference value, the image rewrite control circuit 44 determines whether a difference between the points in time at which the first and second image rewrites are performed is equal to or smaller than a predetermined reference value (e.g., 24 hours) based on information on the time of the first and second image rewrites received from the memory 57 for total rewriting (step ST6).

When it is determined at step ST6 that the time difference is equal to or smaller than the reference value, the image rewrite control circuit 44 selects a rewrite of the region S12 that is a part of the display area RD including the region R0 when the second image rewrite is performed (step ST4; selection of the partial rewrite mode).

When it is determined at step ST5 that the temperature difference is in the excess of the reference value or when it is determined at step ST6 that the time difference is in the excess of the reference value, the image rewrite control circuit 44 selects a rewrite of the entire display area RD when the second image rewrite is performed (step ST7; selection of the full rewrite mode).

The image rewrite control circuit 44 outputs predetermined signals to the scan driver IC 21 and the data driver IC 22 based on the rewrite mode thus selected. The scan driver IC 21 and the data driver IC 22 apply a predetermined pulse voltage to each of the scan electrodes and the data electrodes based on the signals to rewrite the display area DR into an image 200 (step ST8; execution of a rewrite). Thus, the second image rewrite is terminated (step ST9).

### (Modification)

A liquid crystal display element according to a modification of the present embodiment will now be described. In the following description, components identical in functions and operations to components of the liquid crystal display element 1 will be indicated by like reference numerals and will not be described in detail.

The liquid crystal display element of the present modification employs a display section provided by stacking a B display portion having a B liquid crystal layer reflecting blue light in the planar state, a G display portion having a G liquid crystal layer reflecting green light in the planar state, and an R display portion having an R liquid crystal layer reflecting red light in the planar state. The B, G, and R display portions are stacked in the order listed starting at a light-entering surface (display surface) of the element. The R, G, and B display portions are similar in configuration to the display section 6. The liquid crystal display element of the present modification is capable of color display because it has the R, G, and B display portions stacked as described. For example, the number of pixels of the liquid crystal display element of the present modification is 320×240 dots. That is, the liquid crystal display element has the QVGA configuration.

The liquid crystal display element of the present modification employs general-purpose STN drivers as the scan driver IC 21 and the data driver IC 22. As occasion demands, a voltage follower employing an operational amplifier may be used to stabilize a voltage input to each of the drivers. Pulse voltages of ±32 V and ±24V are applied with stability to on-pixels and off-pixels, respectively, of each of the R, G, and B display portions, and a pulse voltage of ±4 V is applied to unselected pixels.

When a partial rewrite is performed at the second image rewrite, the region S12 to perform the partial rewrite is scanned at a speed of, for example, about 10 msec./line. The regions S11 and S13 which are not the subject of the partial rewrite are scanned at a scanning speed on the order of μsec./line, and the scanning is therefore instantaneously finished. It is preferable to turn off the voltage output from the data driver 22 when scanning the regions S11 and S13 which are not the subject of the partial rewrite. However, when the voltage output is equal to or lower than a voltage to which the liquid crystal (pixels) responds at a high-speed scanning, the existing image is kept unchanged. Therefore, no problem arises even if the voltage output is left on.

The image rewriting method for a display element according to the embodiment may be equally applied to the liquid crystal display element of the present modification. The driving voltages and the voltage setting for the driver ICs in the above example are not to be taken in a limiting sense.

The liquid crystal display element of the present embodiment can be preferably used in display sections of electronic paper. The liquid crystal display element of the present embodiment can be preferably used also in display sections of electronic terminals. Such electronic terminals include PDA, cellular telephones, IC cards, and large advertising towers.

### Second Embodiment

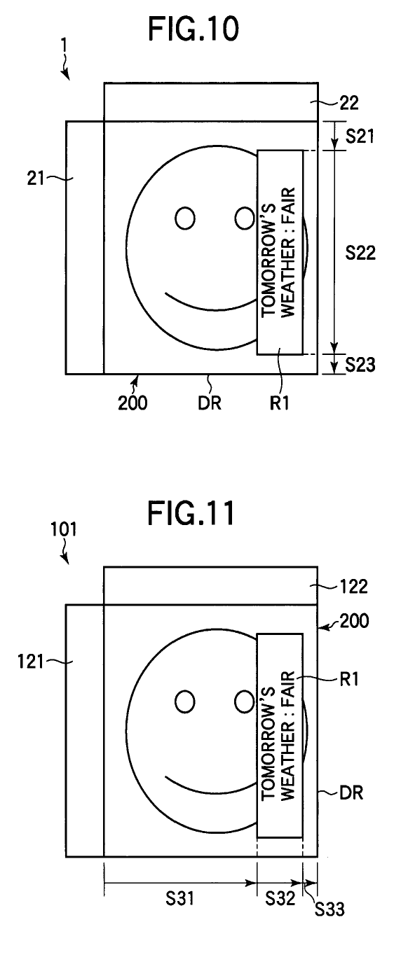

A description will now be made with reference to FIGS. 10 to 12 on a display element, an image rewriting method for the display element, and electronic paper and an electronic terminal utilizing the display element according to a second embodiment of the invention. In the following description, components identical to the first embodiment will be indicated by like reference numerals in the present embodiment and will not be described in detail.

FIG. 10 is an illustration for explaining another problem of the above-described display element driving method according to the related art. FIG. 10 shows a state of a liquid crystal display element 1 after a partial rewrite. Let us assume that a rewritten region R1 has a shape that is long in the scanning direction (the vertical direction of FIG. 10). Then, when viewed in the scanning direction, the display area is mostly occupied by a region S22 which is scanned at a normal speed and which includes the rewritten region R1. Thus, skipped regions S21 and S23 which are scanned at a high speed and in which no rewrite takes place occupy only a small part of the display area. Therefore, effects of high-speed scanning may not be satisfactorily produced.

Specifically, when the display area is mostly covered by a region R1 to be rewritten depicted as FIG. 10 when viewed in the scanning direction, according to the above-described display element driving method in the related art, a major part of the screen is scanned regardless of the fact that a partial rewrite is performed. Therefore, the partial rewrite may not be performed in a short operating time which is an advantage inherent to the operation.

The present embodiment confronts the problem with the above-described display element driving method and provides a display element and a display element driving method in which a further improvement of the speed of a partial screen rewrite can be achieved.

First, the principle of the display element driving method according to the present embodiment will be described. FIG. 11 is an illustration for explaining the principle of the display element driving method according to the present embodiment. A liquid crystal display element 101 utilizing a cholesteric liquid crystal will be described as an example of a display element according to the present embodiment. FIG. 11 shows a state of the liquid crystal display element 101 after a partial rewrite. Depicted as FIG. 11, the liquid crystal display element 101 includes a first driver IC 121 instead of the scan driver IC 21 and a second driver IC 122 instead of the data driver IC 22.

As apparent from a comparison between FIG. 10 and FIG. 11, according to the display element driving method of the present embodiment, when a region R1 to be rewritten has a shape that is long in the vertical direction of the figures, the driver on the side where a smaller number of electrodes are associated with the rewritten region R1 is selected as the scan driver.

Specifically, depicted as FIG. 11, when the rewritten region R1 has a shape that is long in the vertical direction of the figure, the scanning direction is switched to the horizontal direction. Therefore, the vertical driver (first driver IC) 121 in FIG. 11 is used as the data driver, and the horizontal driver (the second driver IC) 122 is used as the scan driver. Image data supplied to the data driver may be converted in each of the case wherein the horizontal driver 122 is used as the data drier and the vertical driver 121 is used as the data driver, and such a conversion is carried out by an image rewrite control circuit 44 which will be described later.

When a region R1 to be rewritten has a shape that is long, for example, in the scanning direction (vertical direction) depicted as FIG. 11, scanning is performed at a normal speed only in a region S32 which is associated with the shorter sides of the region R1 to be rewritten, and scanning is performed at a high speed inmost of the remaining regions, i.e., in regions S31 and S32. Thus, effects of high-speed scanning can be satisfactorily produced.

The display element driving method of the present embodiment may be used in the display element and the electronic paper and the electronic terminal according to the first embodiment. The display element driving method of the present embodiment may be used in combination with the image rewriting method for a display element according to the first embodiment.

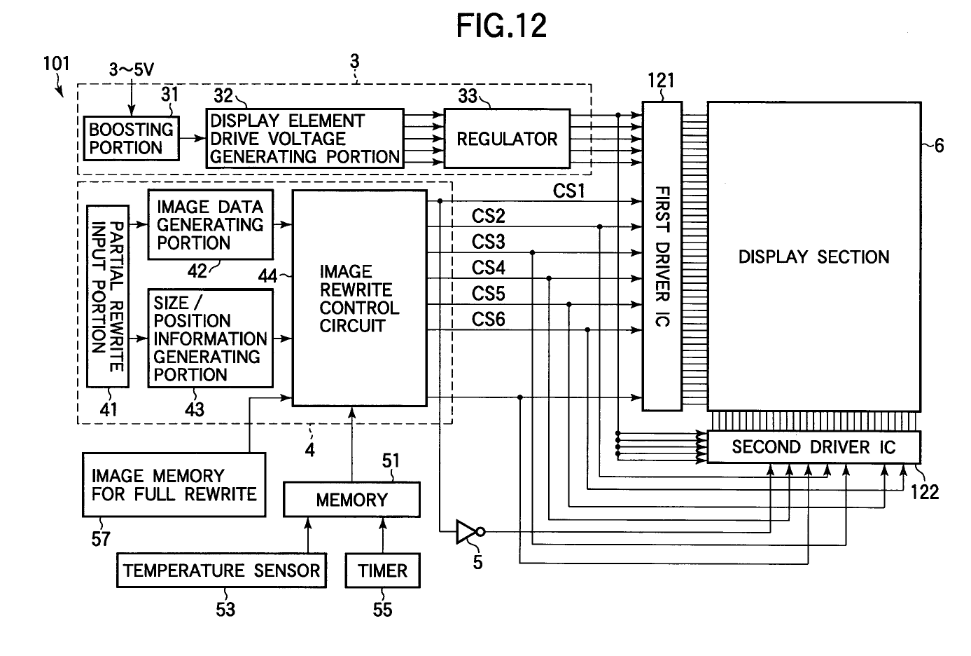

FIG. 12 is a block diagram of the liquid crystal display element 101 according to the present embodiment showing a circuit configuration thereof. Depicted as FIG. 12, the liquid crystal display element 101 includes a power supply circuit 3, a control circuit 4, an inverter 5, a display section 6, a first driver IC 121, and a second driver IC 122. The liquid crystal display element 101 also includes a memory (data storage portion) 51, a temperature sensor 53, a timer 55, and an image memory 57 for total rewriting.

The control circuit 4 includes a partial rewrite input portion 41, an image data generating portion 42, a size/position information generating portion 43, and an image rewrite control circuit (image rewrite control portion) 44. The control circuit 4 carries out calculations of image data and control signals supplied from outside. The circuit sets either the first driver IC 121 or the second driver IC 122 as a scan driver or data driver and sets the other driver IC as a data driver or a scan driver. The circuit also supplies appropriate signals to the scan driver 121 (or 122) and the data driver 122 (or 121) thus set.

The partial rewrite input portion 41 recognizes that the next image rewrite (second image rewrite) to be performed is an image rewrite for rewriting a region R1 that is a part of a display area DR (a partial image rewrite) from the image data and the control signals supplied from outside. The image data generating portion 42 generates image data for the region μl that is the subject of a partial rewrite, and the size/position information generating portion 43 generates size/position information of the region R1 that is the subject of a partial rewrite (information on the position of the region R1 to be rewritten in the screen). The image data and the size/position information of the region R1 to be rewritten is input to the image rewrite control circuit 44.

The image rewrite control circuit 44 outputs a scan/data mode signal CS1, a data fetching clock CS2, a pulse polarity control signal CS3, a frame start signal CS4, a data latch/scan shift signal CS5, and a driver output cut-off signal CS6.

The scan/data mode signal CS1 is a signal indicating which of the first driver IC 121 and the second driver IC 122 is to be set as a scan driver. The scan/data mode signal CS1 is directly input to the first driver IC 121 and input to the second driver IC 122 through an inverter 5. Thus, either of the first driver IC 121 and the second driver IC 122 is set as a scan driver (or set in a scan mode), and the other driver IC is set as a data driver (or set in a data mode).

Specifically, when a region R1 that is apart of a presently displayed image is to be rewritten, the driver connected to the set of electrodes including a smaller number of electrodes associated with the region R1 to be rewritten is selected to be a scan driver, and the driver connected to the set of electrodes including a greater umber of electrodes associated with the region R1 to be rewritten is selected to be a data driver. For example, when the sets of electrodes disposed in the longitudinal and transverse direction of the element include the same number of electrodes associated with the region R1 to be rewritten or when the region R1 to be rewritten has a square shape, the scan driver and data driver are set according to the same selection as made when the presently displayed image was written.

Therefore, when a horizontally long pattern of an image to be partially rewritten (region R1 to be rewritten) is input to the display section 6 depicted in FIG. 12 (the horizontal size of the image is greater than the vertical size of the same), the first driver IC 121 is set in the scan mode (or set as the scan driver), and the second driver IC 122 is set in the data mode (or set as the scan driver). On the contrary, when a vertically long pattern of an image to be partially rewritten (the vertical size of the image is greater than the horizontal size of the same) is input, the first driver IC 121 is set in the data mode, and the second driver IC 122 is set in the scan mode.

Such a selection (setting) of the scan mode and data mode is enabled by the scan/data mode signal CS1 having one bit. For example, when the signal CS1 is at a low level “L”, the driver of interest is set in the scan mode (or set as the scan driver). On the contrary, when the signal CS1 is at a high level “H”, the driver of interest is set in the data mode (or set as the data driver). The setting of the first and second driver ICs 121 and 122 may be made using a variety of other known methods instead of the method described above.

Image data supplied to the second driver IC 122 and the first driver IC 121 may be converted in each of the case wherein the first driver IC 121 extending in the vertical direction of the figure is used as the scan driver and the second driver IC 122 extending in the horizontal direction of the figure is used as the data driver and the case wherein the first driver IC 121 extending in the vertical direction of the figure is used as the data driver and the second driver IC 122 extending in the horizontal direction of the figure is used as the scan driver. The conversion of image data is carried out by the image rewrite control circuit 44. Specifically, the image rewrite control circuit 44 receives the output of the image data generating portion 42 and the size/position information generating portion 43, and not only determines the functions to be performed by each driver in the scan mode or data mode but also re-arrange (convert) image data input to each driver as occasion demands.

When a second image rewrite is performed, the image rewrite control circuit 44 receives information on the temperatures and the points in time at which first and second image rewrites are performed from the memory 51. Based on the information on the temperatures and the times of the previous image rewrite (first image rewrite) and the second image rewrite and information on the size and position of the region R1, the image rewrite control circuit 44 selects a rewrite of the entire display area DR or a rewrite of a region S32 which is a part of the display area DR including the region R1 when the second image rewrite is performed.

### Third Embodiment

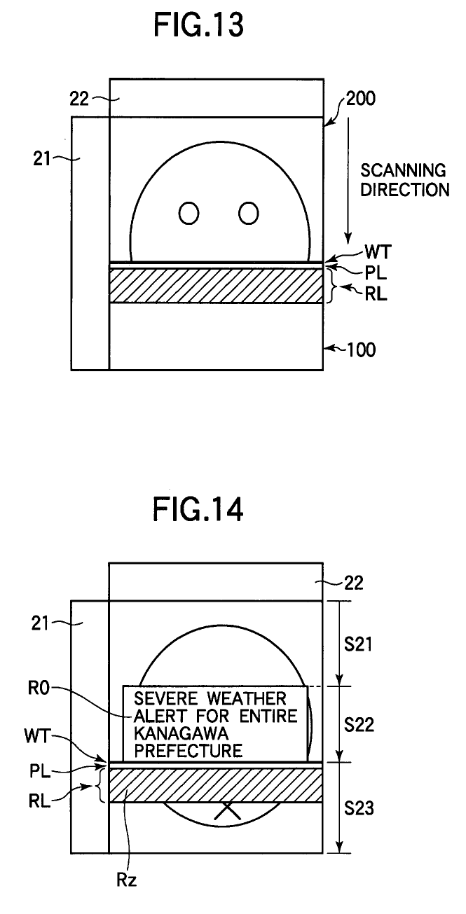

A description will now be made with reference to FIGS. 13 to 23 on a display element, an image rewriting method for the display element, and electronic paper and an electronic terminal utilizing the display element according to a third embodiment of the invention.

When a cholesteric liquid crystal is driven, it is preferable to apply a reset voltage before actually writing an image. In Pamphlet of International Patent Publication No. 2005/024774 (FIGS. 55 and 56 and Embodiment 4), the applicant has proposed an image writing method which allows a reduction in power consumption and stable contrast to be achieved, the method including a write sequence in which an image is actually written after resetting a predetermined number of scan lines and further providing a pause section.

FIG. 13 is an illustration for exemplifying the display element driving method according to the related art proposed in Pamphlet of International Patent Publication No. 2005/024774 mentioned above. Referring to FIG. 13, reference numeral 100 represents a previous image (existing image); reference numeral 21 represents a common-side driver IC (scan driver); reference numeral 22 represents a segment-side driver IC (data driver); and reference numeral 200 represents a new image (an image obtained by a rewrite). FIG. 13 illustrates a state of a screen in which a previous image 100 remains in a lower half of the screen and in which an upper half of the screen has been rewritten into a new image 200.

According to the proposal, when an image rewrite (writing) is performed on, for example, a cholesteric liquid crystal depicted as FIG. 13, the writing of a new image is immediately preceded by an image writing sequence carried out in the same frame, the sequence providing a reset section RS, thereafter providing a pause section PS, and finally providing a write section WS. In FIG. 13, reference characters WT in FIG. 13 represent a write starting line involved in the write sequence; reference characters PL represent pause lines; and reference characters RL represent reset lines.

The number of the reset lines RL (reset section RS) is preferably in the range from about 10 to about 100 (e.g., 20 lines), although it depends on the response characteristics of the liquid crystal. The duration of the reset section RS (reset lines RL) is preferably in the range from about 50 msec. to about 100 msec. The pause section PS (pause lines) may be constituted by one line.

According to the display element driving method in the related art, since the execution of a reset is limited to a certain number of lines, power can be saved in a drastically great amount when compared to the power consumed in instances wherein an entire screen is reset at a time, and an image having a high contrast can be displayed with stability.

However, the above-described display element driving method according to the related art has a problem to be solved as described below.

FIG. 14 is an illustration for explaining a problem in an example of the implementation of the display element driving method according to the related art. In FIG. 14, reference numeral R0 represents a region subject to a partial rewrite; reference numerals S21 and S23 represent regions which are skipped at a high speed (a high-speed skip process); and reference numeral S22 represents a region which is written at a high speed (a high-speed writing process).

Depicted as FIG. 13, according to the above-described display element driving method in the related art, a predetermined number of reset lines RL (e.g., about 20 lines which may alternatively be referred to as “a reset section RS”) may be provided before lines which are actually written. Therefore, in a case wherein a part of a display screen (a region R0 to be rewritten) is rewritten depicted as FIG. 14, a region Rz which is reset by the reset lines RL moves out of the rewritten region R0 when the write line approaches the end of the rewritten region R0, which adversely affects the state of display of the original image which is not to be partially rewritten.

Although a partial rewrite can be carried out without using a reset as described above, stable writing may not be performed unless the speed of the partial rewrite is reduced to, for example, about 20 msec./line. Further, the partial rewrite can become unstable; desired contrast may not be reached because of an afterimage of the pattern displayed before the rewrite which is generated depending on the type of the displayed pattern or generated by some temperature fluctuations. That is, when writing is carried out without a reset process, an afterimage of the pattern displayed before the rewrite, and a reduction in contrast can occur. In addition, since it is difficult to perform a rewrite without a significant reduction in the speed of writing, a reduction of writing time that is an inherent advantage of a partial rewrite may not be achieved.

The present embodiment confronts the above-described problem of the display element driving method according to the related art and provides a display element and a display element driving method utilizing the reset pulses which allow a stable partial rewrite to be carried out without degradation of image quality attributable to an afterimage or a reduction in contrast.

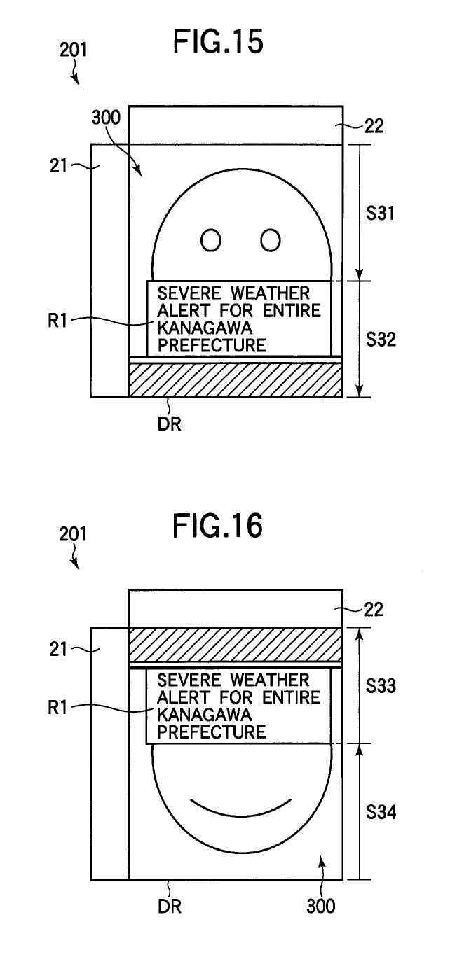

First, the principle of the display element driving method according to the present embodiment will be described. FIGS. 15 and 16 are illustrations for explaining the principle of the display element driving method according to the present embodiment. A liquid crystal display element 201 utilizing a cholesteric liquid crystal will be described as an example of a display element according to the present embodiment.

According to the display element driving method according to the present embodiment, a partial write is performed by applying reset pulses and write pulses in the same frame from the start point up to the end of a display screen just as done in a full rewrite.

When a region R1 that is the subject of a partial rewrite is located in a lower part of a display screen 300 depicted as FIG. 15, scanning is performed in a top-to-bottom direction (a region S31 is first scanned, and a region S32 is scanned thereafter). On the contrary, when a region R1 that is the subject of a partial rewrite is located in an upper part of the display screen 300 depicted as FIG. 16, scanning is performed in a bottom-to-top direction (a region S34 is first scanned, and a region S33 is scanned thereafter). Reference numerals S31 and S34 represent regions in which a high-speed skip process is performed, and reference numerals S32 and S33 represent regions where a high-speed writing is performed.

As thus described, the present embodiment makes it possible to prevent degradation of a state of display outside a region R1, that is the subject of a partial rewrite, attributable to reset lines moving out of the rewritten region as described above. It is therefore possible to achieve a stable partial rewrite without an afterimage or a reduction in contrast.

The display element driving method of the present embodiment may be used in the display element and the electronic paper and the electronic terminal according to the first embodiment. The display element driving method of the present embodiment may be used in combination with the image rewriting method for a display element according to the first embodiment.

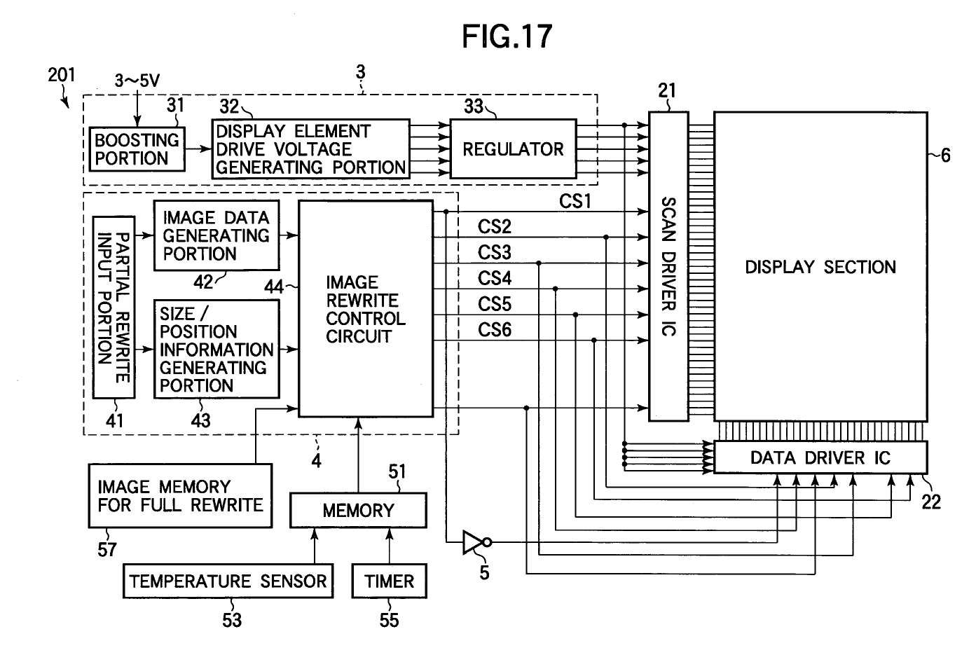

FIG. 17 is a block diagram of the liquid crystal display element 201 according to the present embodiment showing a circuit configuration thereof. Depicted as FIG. 17, the liquid crystal display element 201 includes a power supply circuit 3, a control circuit 4, an inverter 5, a display section 6, a scan driver IC 21, and a data driver IC 22. The liquid crystal display element 201 also includes a memory (data storage portion) 51, a temperature sensor 53, a timer 55, and an image memory 57 for total rewriting.

The control circuit 4 includes a partial rewrite input portion 41, an image data generating portion 42, a size/position information generating portion 43, and an image rewrite control circuit 44. The control circuit 4 carries out calculations of image data and control signals supplied from outside. When the pattern of an image that is the subject of a partial rewrite is input along with the position in a display screen where the partial rewrite is to be performed, the image rewrite control circuit 44 determines the scanning direction of the scan driver 21 according to those pieces of information and re-arranges image data input to the driver 21 as occasion demands.

The partial rewrite input portion 41 recognizes that the next image rewrite (second image rewrite) to be performed is an image rewrite for rewriting a region R1 that is a part of a display area DR (a partial image rewrite) from the image data and the control signals supplied from outside. The image data generating portion 42 generates image data for the region R1 that is the subject of a partial rewrite, and the size/position information generating portion 43 generates size/position information of the region R1 that is the subject of a partial rewrite (information on the position of the region R1 to be rewritten in the screen). The image data and the size/position information of the region R1 to be rewritten is input to the image rewrite control circuit 44.

The image rewrite control circuit 44 outputs a scan direction signal CS1 determining the scanning direction of the scan driver 21 as described above, a data fetching clock CS2, a pulse polarity control signal CS3, a frame start signal CS4, a data latch/scan shift signal CS5, and a driver output cut-off signal CS6.

Specifically, when a partial region of a presently displayed image is to be rewritten, a top-to-bottom direction of the display screen is set as the scanning direction if the region to be rewritten is located in a lower part of the display screen. On the contrary, when the region that is the subject of a partial rewrite is located in an upper part of the display screen, a bottom-to-top direction of the display screen is set as the scanning direction.

When the second image rewrite is performed, the image rewrite control circuit 44 receives information on the temperatures and the points in time at which the first and second image rewrites are performed from the memory 51. Based on the information on the temperatures and the time of the previous image rewrite (first image rewrite) and the second image rewrite and information on the size and position of the region R1, the image rewrite control circuit 44 selects a rewrite of the entire display area DR or a rewrite of a region S32 (or a region S33) which is a part of the display area DR including the region R1 when the second image rewrite is performed.

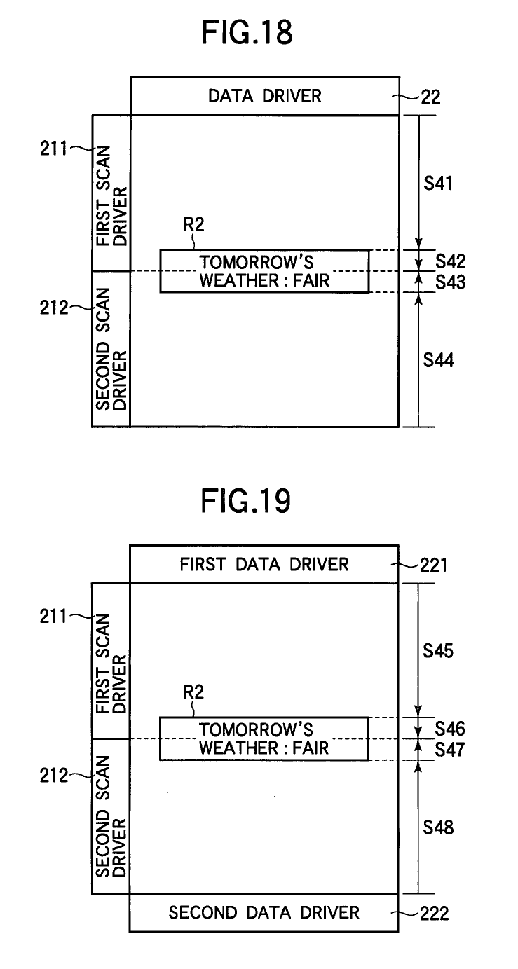

FIG. 18 is an illustration for explaining an example of the implementation of the display element driving method according to the present embodiment. In the display element depicted in FIG. 18, a common-side driver (scan driver 21) is constituted by two scan drivers 211 and 212, and a segmented-side driver is constituted by one data driver 22 provided at one end (top end) of the display screen.

The display element is driven as follows when a region R2, which is the subject of a partial rewrite, extends across the positions of the two scan drivers 211 and 212. Since the region R2 to be rewritten is in a position associated with the first scan driver 211 in a lower part of the display screen, the top-to-bottom direction of the display screen is set as the scanning direction of the scan driver 211. The first scan driver 211 first performs a process of skipping a region S41 at a high speed, and the first scan driver 211 then starts an image rewrite in a region S42 associated with a part of the region R2 to be rewritten.

Since the region R2 to be rewritten is located also in a position associated with the second scan driver 212 in an upper part of the display screen, the bottom-to-top direction of the display screen is set as the scanning direction of the scan driver 212. Subsequently to the scanning by the first scan driver 211, the second scan driver 212 performs a process of skipping a region S44 at a high speed, and the second scan driver 212 then starts an image rewrite in a region S43 associated with a part of the region R2 to be rewritten.

FIG. 19 is an illustration for explaining a modification of the display element driving method depicted in FIG. 18. The above description has addressed a display element in which a common-side driver is constituted by two scan drivers 211 and 212 and in which a segmented-side driver is constituted by one data driver 22 provided at one end (top end) of the display screen, depicted as FIG. 18. The description equally applies to, for example, a display element in which a common-side driver is constituted by two scan drivers 211 and 212 and in which a segmented-side driver is constituted by two data drivers 221 and 222 provided at two ends (top and bottom ends) of the display screen, depicted as FIG. 19.

In the display element having the two scan drivers 211 and 212 depicted as FIG. 19, a first write process using the first scan driver 211 and the first data driver 221 can be performed in parallel (simultaneously) with a second write process using the second scan driver 212 and the second data driver 222. Specifically, in the display element (display apparatus) depicted in FIG. 19, a process of skipping a region S45 at a high speed in a top-to-bottom (downward) scanning direction performed by the first scan driver 211 proceeds simultaneously with a process of skipping a region S48 at a high speed in a bottom-to-top (upward) scanning direction performed by the second scan driver 212. Further, a process of downwardly writing a region S46 at a high speed performed by the first scan driver 211 proceeds simultaneously with a process of upwardly writing a region S47 at a high-speed performed by the second scan driver 212. Thus, a further reduction can be achieved in the time required for a partial rewrite.

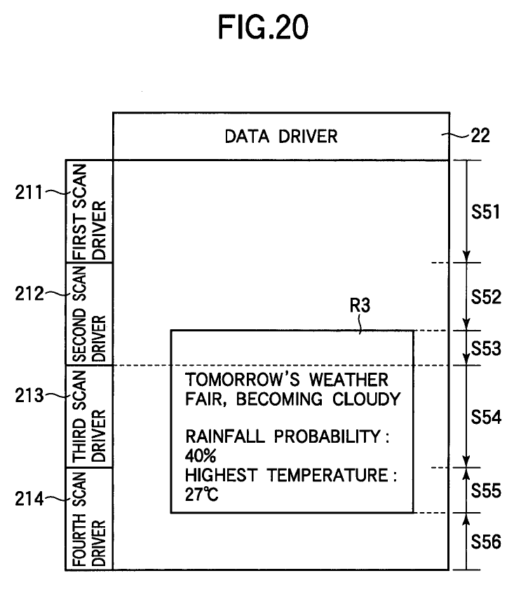

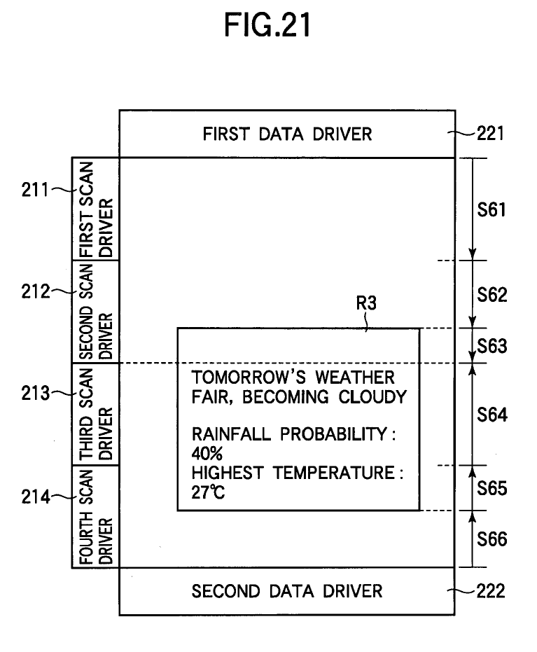

FIGS. 20 and 21 are illustrations for explaining another example of the implementation of the display element driving method according to the present embodiment.

In the display element depicted in FIG. 20, a common-side driver (scan driver 21) is constituted by four scan drivers 211 to 214. In the display element depicted in FIG. 21, not only a common-side driver is constituted by four scan drivers 211 to 214 just as in the display element depicted in FIG. 20, but also a segmented-side driver (data driver 22) is constituted by a plurality of data drivers, i.e., two data drivers 221 and 222 provided on the top and bottom ends of the display screen.

Let us assume that the first to fourth scan drivers 211 to 214 and an image (a region R3) which is the subject of a partial rewrite are in a positional relationship depicted as FIG. 20. Then, for example, a series of processes is performed as follows. The first scan driver 211 performs a process of downwardly skipping a region S51 at a high speed. Then, the second scan driver 212 performs a process of downwardly skipping a region S52 at a high speed. Next, the second scan driver 212 performs a process of downwardly writing a region S53 at a high speed. The third scan driver 213 then performs a process of downwardly writing a region S54 at a high speed. Thereafter, the fourth scan driver 214 performs a process of upwardly skipping a region S56 at a high speed. Then, the fourth scan driver 214 performs a process of upwardly writing a region S55 at a high speed.

Let us assume that the first to fourth scan drivers 211 to 214 and the region R3 which is the subject of a partial rewrite are in a positional relationship depicted as FIG. 21. Then, for example, a series of processes is performed as follows. A process of downwardly skipping a region S61 at a high speed is performed by the first scan driver 211 simultaneously with a process of upwardly skipping a region S66 at a high speed performed by the fourth scan driver 214. Further, a process of downwardly skipping a region S62 at a high speed is performed by the second scan driver 212 simultaneously with a process of upwardly writing a region S65 at a high speed performed by the fourth scan driver 214. Then, a process of downwardly writing a region S63 at a high speed is performed by the second scan driver 212 simultaneously with a process of upwardly writing a region S64 at a high speed performed by the third scan driver 213.

As thus described, a plurality of scan drivers may be provided on the common side. In addition, the data driver on the segment side may be also disposed with flexibility. Specifically, one data driver may be provided at one end of the display screen, and two data drivers may alternatively be provided on two ends of the display screen.

Predetermined display characteristics may not be achieved on, for example, several lines including the starting line of a partial rewrite because a write pulse is directly applied to those lines without a reset pulse or because the reset pulse is applied to an insufficient number of lines. Under the circumstance, for example, it is preferable to apply a reset pulse in advance to the lines to which no reset pulse will otherwise be applied or to increase the pulse application time by reducing the scan speed.

As described above with reference to FIG. 14 and so on, according to the display element driving method in the related art, when a part of a display screen (a region R0 to be rewritten) is rewritten, a region Rz which is reset by reset lines RL moves out of the rewritten region R0 when the write line approaches the end of the rewritten region R0, which adversely affects the state of display of the original image which is not to be partially rewritten. When a partial rewrite is performed without a reset, the writing speed may be significantly decreased, which has disabled a reduction in writing time that is an inherent advantage of a partial write.

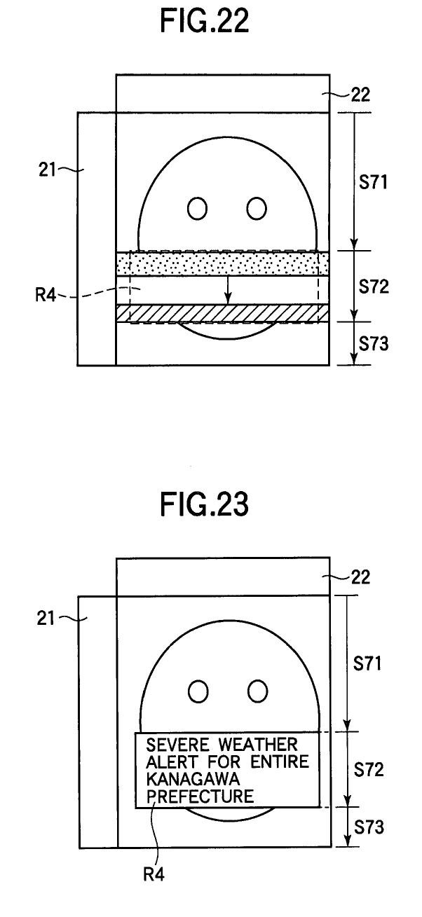

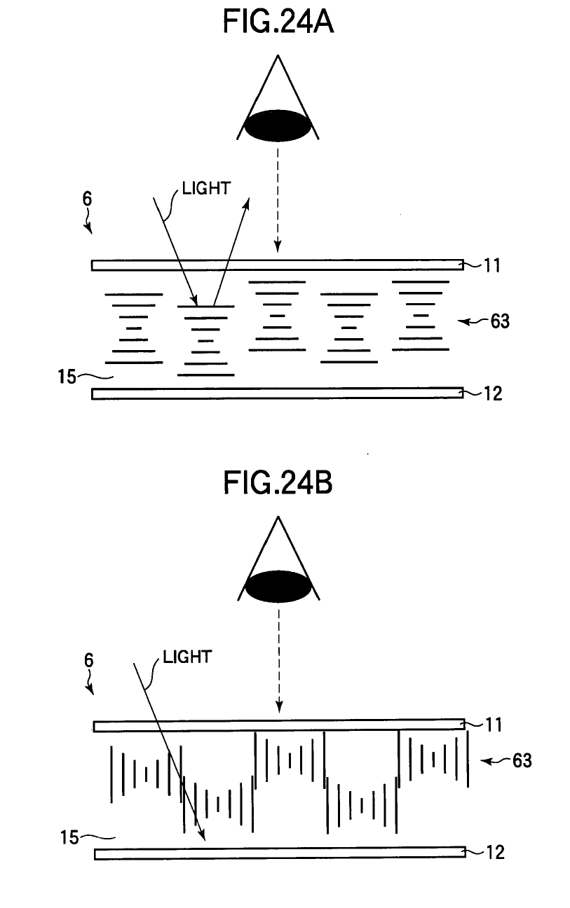

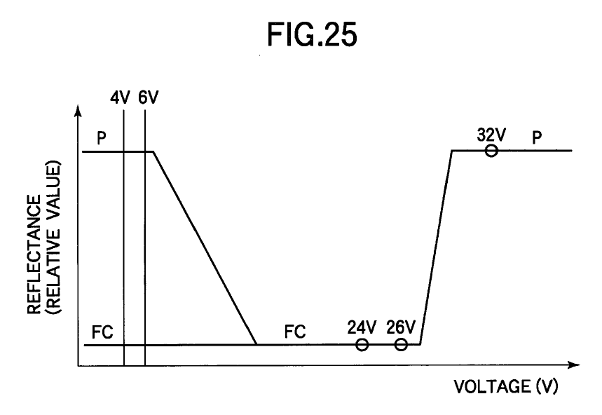

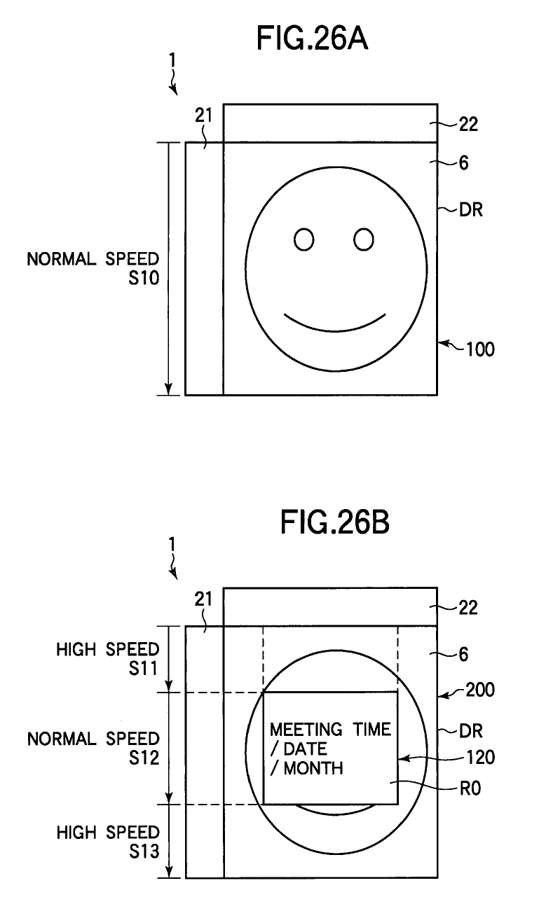

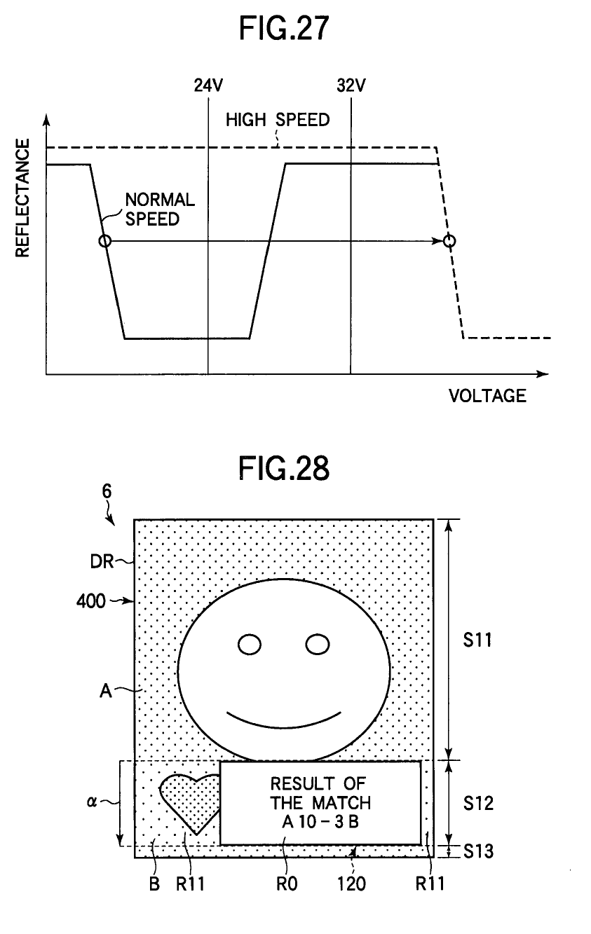

FIGS. 22 and 23 are illustrations for explaining another example of the implementation of the display element driving method according to the embodiment.

The display element driving method of the present embodiment is characterized in that a reset section and a write section are provided in different frames (frame division) when a partial rewrite is performed.

Specifically, depicted as FIG. 22, a process of skipping a region S71 at a high speed is performed in a first frame, for example, in the top-to-bottom scanning direction. Then, a process of resetting scan lines (a region S72) associated with a region R4 which is the subject of a partial rewrite is performed. Further, a process of skipping a region S73 at a high speed is performed. As a result, in the liquid crystal display element utilizing a cholesteric liquid crystal, the region S72 associated with the region R4 which is the subject of a partial rewrite enters the planar state.

In the next frame, i.e., a second frame, a process of skipping a region S71 at a high speed is performed, for example, in the top-to-bottom scanning direction. Then, a process of writing a rewrite image is performed at a high speed in the region S72 associated with the partially rewritten region R4, which is further followed by a process of skipping a region S73 at a high speed.

While the partially rewritten region is being scanned, voltage differences between the scan electrodes and the data electrodes are equal to or lower than a response voltage of the light reflector (e.g., a cholesteric liquid crystal).

Thus, it is possible to prevent a reset region (Rz) from moving out of a rewritten region. Since a selected number of lines are limited in a reset section, any increase in power consumption can be avoided.

In this case, predetermined display characteristics may not be achieved again on, for example, several lines including the starting and end lines of a partial rewrite because the number of reset lines is insufficient when the scan speed is kept constant. Under the circumstance, it is advantageous to compensate for the effect of a reset by decreasing the scan speed to increase the pulse application time when the starting and end lines of the partial rewrite are selected by a reset pulse. In this case, the reset time equals the scan speed multiplied by the number of reset lines.

The invention is not limited to liquid crystal display elements utilizing a cholesteric liquid crystal and may be applied to, for example, other types of display elements having the property of memorizing a state of display and electronic paper and electronic terminals utilizing the display elements. For example, such display elements include display elements utilizing electrophoresis and electron flow dividers.

What is claimed is:

1. A display element comprising:
a display section having a light reflector and a display area on which an image is displayed based on the state of the light reflector;
a data storage portion for storing first environmental data when a first image rewrite is performed to rewrite the entire display area into a first image and second environmental data when a second image rewrite is performed to rewrite a first region that is a part of the display area into a second image; and
an image rewrite control portion for selecting a rewrite of the entire display area or a rewrite of the second region that is a part of the display area including the first region when the second image rewrite is performed based on the first and second environmental data and/or the second image.

2. The display element according to claim 1, wherein the image rewrite control portion selects the rewrite of the entire display area when a color difference between the color of the second region after the second image rewrite and the color of the display area excluding the second region is greater than a predetermined value and selects the rewrite of the second region when the color difference is equal to or smaller than the predetermined value.

3. The display element according to claim 2, wherein the predetermined value of color difference is substantially a color difference ΔE*ab of 3 in an L*a*b* color space.

4. The display element according to claim 1, wherein:
the first environmental data includes a temperature of the neighborhood of the display section measured when the first image rewrite is performed;
the second environmental data includes a temperature of the neighborhood of the display section measured when the second image rewrite is performed; and
the image rewrite control portion selects the rewrite of the entire display area in performing the second image rewrite when a difference between the temperatures measured at the time of the first image rewrite and the second image rewrite is equal to or greater than a predetermined value.

5. The display element according to claim 1, wherein:
the first environmental data includes time at which the first image rewrite is performed;
the second environmental data includes time at which the second image rewrite is performed; and
the image rewrite control portion selects the rewrite of the entre display area in performing the second image rewrite when a difference between the time of the first image rewrite and the time of the second image rewrite is equal to or greater than a predetermined value.

6. The display element according to claim 1, wherein:
the display section includes a plurality of first electrodes, a plurality of second electrodes disposed to intersect the plurality of first electrodes, and a plurality of pixels each of which is disposed at an intersection between the plurality of first and second electrodes; and
the light reflector is driven by applying a voltage to the plurality of first and second electrodes.

7. The display element according to claim 6, wherein the second region is a region formed by the plurality of first electrodes on which the plurality of pixels associated with the second image are disposed.

8. The display element according to claim 7, wherein the image rewrite control portion selects the rewrite of the second region in performing the second image rewrite regardless of the first and second environmental data when the first region coincides with the second region and the gray levels of the plurality of pixels in the second region are all different from the gray levels of the plurality of pixels in the display area excluding the second region.

9. The display element according to claim 6, further comprising:
a driving section for scanning the plurality of first electrodes in a predetermined order and applying a voltage to the plurality of first and second electrodes to drive the light reflector, wherein
the driving section scans all of the plurality of first electrodes when the second image rewrite is performed and applies a voltage to the plurality of first and second electrodes such that a voltage applied to the light reflector becomes equal to or lower than a threshold voltage at which the light reflector responds while scanning the plurality of first electrodes in the display area excluding the second region.

10. The display element according to claim 1, wherein the light reflector has memory characteristics.

11. The display element according to claim 1, wherein the light reflector is a liquid crystal which forms a cholesteric phase.

12. Electronic paper comprising a display element according to claim 1.

13. The electric terminal comprising a display element according to claim 1.

14. An image rewriting method for a display element having a display section including a light reflector and a display area in which an image is displayed based on the state of the light reflector, the method comprising:
storing first environmental data when a first image rewrite is performed to rewrite the entire display area into a first image and second environmental data when a second image rewrite is performed to rewrite a first region that is a part of the display area into a second image; and
selecting a rewrite of the entire display area or a rewrite of the second region that is a part of the display area including the first region when the second image rewrite is performed based on the first and second environmental data and/or the second image.

15. The image rewriting method for a display element according to claim 14, wherein an image rewrite control portion selects the rewrite of the entire display area when a color difference between the color of the second region after the second image rewrite and the color of the display area excluding the second region is greater than a predetermined value and selects the rewrite of the second region when the color difference is equal to or smaller than the predetermined value.

16. The image rewriting method for a display element according to claim 15, wherein the predetermined value of color difference is substantially a color difference ΔE*ab of 3 in an L*a*b* color space.

17. The image rewriting method for a display element according to claim 14, wherein:
the first environmental data includes a temperature of the neighborhood of the display section measured when the first image rewrite is performed;
the second environmental data includes a temperature of the neighborhood of the display section measured when the second image rewrite is performed; and
the rewrite of the entire display area is selected in performing the second image rewrite when a difference between the temperatures measured at the time of the first image rewrite and the second image rewrite is equal to or greater than a predetermined value.

18. The image rewriting method for a display element according to claim 14, wherein:
the first environmental data includes time at which the first image rewrite is performed;
the second environmental data includes time at which the second image rewrite is performed; and
an image rewrite control portion selects the rewrite of the entre display area in performing the second image rewrite when a difference between the time of the first image rewrite and the time of the second image rewrite is equal to or greater than a predetermined value.

19. The image rewriting method for a display element according to claim 14, wherein:
the display section includes a plurality of first electrodes, a plurality of second electrodes disposed to intersect the plurality of first electrodes, and a plurality of pixels each of which is disposed at an intersection between the plurality of first and second electrodes; and
the light reflector is driven by applying a voltage to the plurality of first and second electrodes.

20. The image rewriting for a display element according to claim 19, wherein the second region is a region formed by the plurality of first electrodes on which the plurality of pixels associated with the second image are disposed.
